(19) United States
(12) Patent Application Publication
(10) Pub. No.: US 2014/0006988 A1
(43) Pub. Date: Jan. 2, 2014

(54) CONTENT DISPLAY DEVICE, CONTENT DISPLAY METHOD, PROGRAM, AND RECORDING MEDIUM

(71) Applicants: Hiroyuki Yamamura, Osaka-shi (JP); Haruo Hinode, Osaka-shi (JP)

(72) Inventors: Hiroyuki Yamamura, Osaka-shi (JP); Haruo Hinode, Osaka-shi (JP)

(73) Assignee: SHARP KABUSHIKI KAISHA, Osaka-shi, Osaka (JP)

(21) Appl. No.: 14/005,443

(22) PCT Filed: Apr. 3, 2012
(86) PCT No.: PCT/JP2012/059117

§ 371 Date: Sep. 16, 2013

(30) Foreign Application Priority Data
Apr. 15, 2011 (JP) 2011-091535

(51) Int. Cl. G06F 3/0481

(52) U.S. Cl. CPC G06F 3/0481
USPC 715/765

(57) ABSTRACT

The content display device includes (i) a display section for displaying, on a screen (20), a plurality of thumbnail images (12) arranged in a first arrangement, (ii) an input operation section for accepting, from a user, an input of an instruction on changing a display size of the thumbnail image (12), a scaling up/down display processing section for changing a display size of a predetermined number of thumbnail images (12), and a moving display processing section for moving the predetermined number of thumbnail images (12) on the screen (20) such that the predetermined number of thumbnail images (12) are displayed in a second arrangement.

### TECHNICAL FIELD

The present invention relates to a content display device which changes a display size of contents and moves the contents to locations where an arrangement of the contents has been changed, a content display method, a program for the content display device, and a storage medium in which the program is stored.

### BACKGROUND ART

Conventionally, there have been known terminals each having a browser function of arranging and displaying a plurality of thumbnail images. Many of these terminals each arrange and display, on a two-dimensional plane, a plurality of icons or thumbnail images.

For example, according to a PC, in a case where a window size is changed, an arrangement of icons is changed in accordance with the changed window size.

In a case where a size of such an icon or thumbnail image is changed, a size of the entire screen including the icon or thumbnail image whose size has been changed is changed. For example, in a case a thumbnail image is scaled up, the other thumbnail images are also scaled up, so that the thumbnail image may not be displayed on the screen. In order to view the thumbnail image which is not displayed on the screen as described above, a user needs to carry out an operation such as scrolling.

In view of the circumstances, Patent Literature 1 describes a method for changing an arrangement of options in a display section in association with the number of displayed rows which is increased or decreased in accordance with a change in scaling.

### CITATION LIST

### Patent Literatures

### Patent Literature 1

Japanese Patent Application Publication, Tokukai, No. 2009-87338 (Publication Date: Apr. 23, 2009)

### SUMMARY OF INVENTION

### Technical Problem

However, according to the method described in Patent Literature 1, with reference to an option located on the upper left of a screen, an arrangement of the other options is changed. For example, in a case where an option intended to be scaled up is located on the upper right of the screen, there is a problem that it is necessary to look for where in the screen that option is located after the option is scaled up.

This configuration is described below with reference to the drawings. FIG. 38 is a view illustrating an example of a screen 20 on which a plurality of thumbnail images 12 are displayed. In a case where a thumbnail image 12 is scaled up in an image (hereinafter referred to as “normal display image”) in which the plurality of thumbnail images 12 is displayed in 4 columns×5 rows on the screen 20, an image (hereinafter referred to as “first scaled-up image”) is displayed in which the plurality of thumbnail images 12 are displayed in 3 columns×4 rows on the screen 20. Further, in a case where the thumbnail image 12 is further scaled up in the screen 20 on which the first scaled-up image is displayed, an image (hereinafter referred to as “second scaled-up image”) is displayed in which the plurality of thumbnail images 12 are displayed in 2 columns×3 rows on the screen 20. Note that in FIG. 38, numbers 1 through 20 given to the respective plurality of thumbnail images 12 are IDs (thumbnail IDs) for identifying the plurality of thumbnail images 12.

In a case where a user scales up, in the screen 20 on which the normal display image is displayed, a thumbnail image 12 which is displayed in the fourth row of the third column and has a thumbnail ID of 15, the first scaled-up image is displayed on the screen 20 in which (i) all the plurality of thumbnail images 12 are scaled up and (ii) the thumbnail images 12, whose arrangement has been changed, are arranged in an order from the upper left of the screen 20. Therefore, in order to view the thumbnail image 12 which has the thumbnail ID of 15, it is necessary to scroll down to a lower part of the screen 20.

Similarly, in a case where the user scales up, in the display screen 20 on which the first scaled-up image is displayed, a thumbnail image 12 which is displayed in the third row of the second column and has a thumbnail ID of 8, the second scaled-up image is displayed on the screen 20 in which (i) all the plurality of thumbnail images 12 are scaled up and (ii) the thumbnail images 12, whose arrangement has been changed, are displayed in an order from the upper left of the screen 20. Therefore, in order to view the thumbnail image 12 which has the thumbnail ID of 8, it is necessary to scroll down to the lower part of the screen.

As described above, according to the conventional technique, in a case where a size of a thumbnail image 12 is changed, the thumbnail image 12 may not be displayed on the screen after the size of the thumbnail image 12 is changed. Therefore, in order to display the thumbnail image 12 which is not displayed on the screen, a user needs to carry out an operation such as scrolling. This is inconvenient to the user. Under the circumstances, the present invention has been made in view of the problems, and an object of the present invention is to provide a content display device having a user interface which can be easily operated by a user.

### Solution to Problem

In order to attain the object, a content display device of the present invention includes: display means for displaying a plurality of contents on a screen in a first arrangement, which is a predetermined arrangement order of contents; input means for accepting, from a user, an input of an instruction on changing a display size of a specified content which is any of the plurality of contents displayed on the screen; changing means for changing a display size of a predetermined number of contents when the input has been accepted, the predetermined number of contents (i) including the specified content and (ii) being sequentially arranged on the screen in accordance with the predetermined arrangement order; and moving means for moving the predetermined number of contents on the screen such that the predetermined number of contents are displayed on the screen in a second arrangement, which is a predetermined arrangement order of contents and is different from the first arrangement.

According to the configuration, in a case where the user carries out an input of an instruction, with respect to a display of contents, on changing (i.e., scaling up or scaling down) a display size of a specified content which has been specified out of the plurality of contents, the specified content is surely displayed on the screen after the display size has been changed. In other words, the specified content will not disappear from the screen after the display size has been changed. Therefore, the user does not need to scroll the screen in order to display the specified content on the screen after the display size has been changed.

Contents, which respectively precedes and follows the specified content before the display size is changed, are to still precede and follow the specified content, respectively, even after the display size is changed. That is, the plurality of contents will not be displayed in a discrete manner. This allows the user to always feel consistency in the arrangement of the contents, and therefore the user can comfortably operate the content display device.

As such, according to the present invention, it is possible to provide the content display device that has a user interface which can be easily operated by the user.

In order to attain the object, a method of the present invention for displaying a content includes the steps of: displaying a plurality of contents on a screen in a first arrangement, which is a predetermined arrangement order of contents; accepting, from a user, an input of an instruction on changing a display size of a specified content which is any of the plurality of contents displayed on the screen; changing a display size of a predetermined number of contents when the input has been accepted, the predetermined number of contents (i) including the specified content and (ii) being sequentially arranged on the screen in accordance with the predetermined arrangement order; and moving the predetermined number of contents on the screen such that the predetermined number of contents are displayed on the screen in a second arrangement, which is a predetermined arrangement order of contents and is different from the first arrangement.

According to the configuration, it is possible to bring about an effect similar to that of the content display device of the present invention.

Note that the content display device can be realized by a computer. In such a case, the present invention encompasses (i) a program which causes the computer to serve as each of the means of the content display device and (ii) a computer-readable storage medium in which the program is stored.

### Advantageous Effects of Invention

The content display device of the present invention includes: display means for displaying a plurality of contents on a screen in a first arrangement, which is a predetermined arrangement order of contents; input means for accepting, from a user, an input of an instruction on changing a display size of a specified content which is any of the plurality of contents displayed on the screen; changing means for changing a display size of a predetermined number of contents when the input has been accepted, the predetermined number of contents (i) including the specified content and (ii) being sequentially arranged on the screen in accordance with the predetermined arrangement order; and moving means for moving the predetermined number of contents on the screen such that the predetermined number of contents are displayed on the screen in a second arrangement, which is a predetermined arrangement order of contents and is different from the first arrangement.

According to the present invention, it is possible to provide the content display device that has a user interface which can be easily operated by the user.

### BRIEF DESCRIPTION OF DRAWINGS

FIG. 1 is a view illustrating an example of a display screen of a content display device, in accordance with Embodiment 1.

FIG. 2 is a view illustrating an example of a bookshelf object and a display screen of the content display device, in accordance with Embodiment 1.

FIG. 3 is an explanatory view. (a) and (b) of FIG. 3 illustrate how fingers are moved in order to give a scaling-up instruction, and (c) and (d) of FIG. 3 illustrate how fingers are moved in order to give a scaling-down instruction.

FIG. 4 is a view illustrating display screens. (a) of FIG. 4 illustrates an example of a display screen of the content display device in accordance with the present embodiment, and (b) and (c) of FIG. 4 illustrate display screens which are displayed when a scaling-up instruction is given on the screen illustrated in (a) of FIG. 4.

FIG. 5 is a block diagram illustrating a configuration of main parts of a content display device.

FIG. 6 is a block diagram illustrating a hardware configuration of a content display device, which is achieved by the use of a computer, in accordance with the present embodiment.

FIG. 7 is a flowchart illustrating an example flow of a scaling-up process, in accordance with Embodiment 1.

FIG. 8 is a flowchart illustrating an example flow of the pre-scaling-up coordinate calculation process in FIG. 7.

FIG. 9 is a flowchart illustrating an example flow of the post-scaling-up coordinate calculation process in FIG. 7.

FIG. 10 is a flowchart illustrating an example flow of the scaling-up animation registration process in FIG. 7.

FIG. 11 is a flowchart illustrating an example flow of the moving animation registration process in FIG. 7.

FIG. 12 is a view illustrating display screens. (a) of FIG. 12 illustrates an example of a display screen of the content display device in accordance with the present embodiment. (b) of FIG. 12 illustrates a display screen in which thumbnail images have been scaled up from those on the screen illustrated in (a) of FIG. 12. (c) of FIG. 12 illustrates a display screen in which an arrangement of has been changed from the screen illustrated in (b) of FIG. 12.

FIG. 13 is a view illustrating display screens. (a) of FIG. 13 illustrates a display screen in which an arrangement on the screen illustrated in (b) of FIG. 12 has been changed. (b) of FIG. 13 illustrates a display screen in which fitting has been carried out with respect to the screen illustrated in (a) of FIG. 13.

FIG. 14 is a view illustrating display screens. (a) of FIG. 14 illustrates locations and a size of thumbnail images displayed on a normal display screen. (b) of FIG. 14 illustrates locations and a size of thumbnail images displayed on a first scaled-up screen. (c) of FIG. 14 illustrates locations and a size of thumbnail images displayed on a second scaled-up screen.

FIG. 15 is a view illustrating, in (a) and (b), lists of locations and sizes of thumbnail images in each screen.

FIG. 16 is a view illustrating an example of locations and sizes of thumbnail images, in accordance with Embodiment 1.

FIG. 17 is a view illustrating display screens. (a) of FIG. 17 illustrates an example of a display screen in accordance with the present embodiment. (b) of FIG. 17 illustrates an example of a location of a thumbnail image, which has a thumbnail ID of 1, after a scaling-up process has been carried out.

FIG. 18 is a view illustrating display screens. (a) of FIG. 18 illustrates an example of a display screen in accordance with the present embodiment. (b) of FIG. 18 illustrates another example of a location of the thumbnail image, which has the thumbnail ID of 1, after a scaling-up process has been carried out.

FIG. 19 is a view illustrating display screens. (a) of FIG. 19 illustrates an example of a display screen in accordance with the present embodiment. (b) of FIG. 19 illustrates a display screen in which a scaling-up animation and a moving animation are simultaneously performed. (c) of FIG. 19 illustrates a display screen in which the scaling-up process and the moving process have been carried out.

FIG. 20 is a view for explaining, in each of (a) through (e), a row in which one (1) thumbnail image, which has been specified and scaled up out of a plurality of thumbnail images displayed on a normal display screen, is displayed on a first scaled-up screen.

FIG. 21 is a view for explaining, in each of (a) through (d), a row in which one (1) thumbnail image, which has been specified and scaled up out of a plurality of thumbnail images displayed on a first scaled-up screen, is displayed on a second scaled-up screen.

FIG. 22 is a flowchart illustrating another example flow of the post-scaling-up coordinate calculation process in accordance with Embodiment 1.

FIG. 23 is a flowchart illustrating an example flow of a scaling-down process in accordance with Embodiment 2.

FIG. 24 is a flowchart illustrating an example flow of the pre-scaling-down coordinate calculation process in FIG. 23.

FIG. 25 is a flowchart illustrating an example flow of the post-scaling-down coordinate calculation process in FIG. 23.

FIG. 26 is a flowchart illustrating an example flow of the scaling-down animation registration process in FIG. 23.

FIG. 27 is a flowchart illustrating an example flow of the moving animation registration process in FIG. 23.

FIG. 28 is a view for explaining, in each of (a) through (d), a row in which one (1) thumbnail image, which has been specified and scaled down out of a plurality of thumbnail images displayed on a first scaled-up screen, is displayed on a normal display screen.

FIG. 29 is a view for explaining, in each of (a) through (c), a row in which one (1) thumbnail image, which has been specified and scaled down out of a plurality of thumbnail images displayed on a second scaled-up screen, is displayed on a first scaled-up screen.

FIG. 30 is a flowchart illustrating another example flow of a post-scaling-down coordinate calculation process in accordance with Embodiment 2.

FIG. 31 is a view for explaining an alignment of thumbnail images carried out in a case where a blank row exists in an upper part of a normal display screen.

FIG. 32 is a view for explaining an alignment of thumbnail images carried out in a case where a blank row exists in a lower part of a normal display screen.

FIG. 33 is a view illustrating an example of a display screen displaying a shelf surface of a bookshelf object in accordance with Embodiment 3.

FIG. 34 is a view illustrating a display screen which is displayed after a button is tapped or a magazine rack is flicked on the display screen illustrated in FIG. 33.

FIG. 35 is a view illustrating the number of books displayed on each screen.

FIG. 36 illustrates display screens. (a) of FIG. 36 illustrates an example of a display screen in accordance with Embodiment 4. (b) and (c) of FIG. 36 illustrate an example of screens on which scaling-up settings are displayed.

FIG. 37 illustrates display screens. (a) of FIG. 37 illustrates a list of thumbnail images displayed on a normal display screen in accordance with Embodiment 4. (b) of FIG. 37 illustrates a list of thumbnail images displayed on a first scaled-up screen. (c) of FIG. 37 illustrates a list of thumbnail images displayed on a second scaled-up screen.

FIG. 38 is a view illustrating an example of a screen on which a plurality of thumbnail images are displayed.

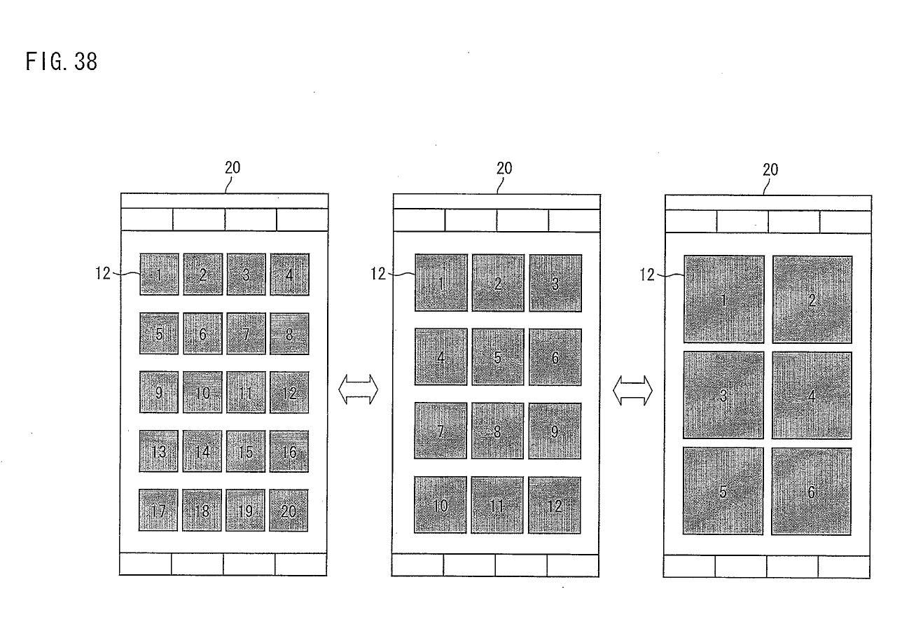

### DESCRIPTION OF EMBODIMENTS

### Embodiment 1

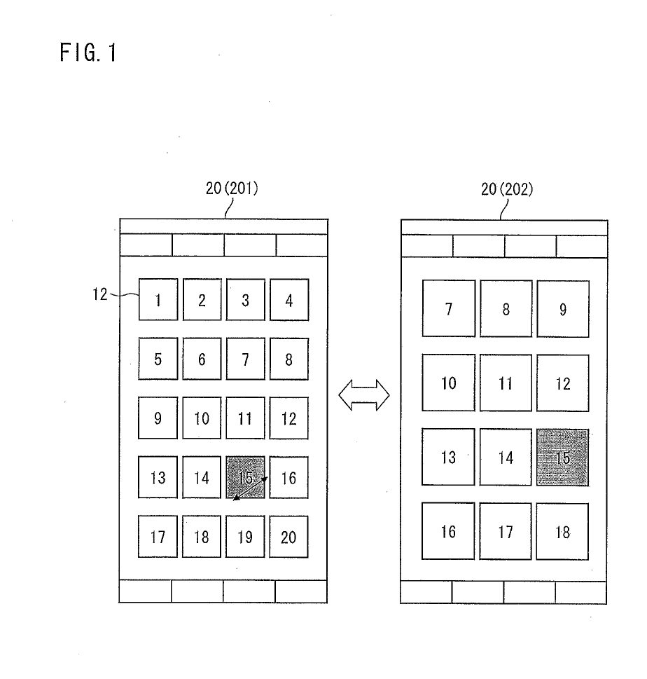

The following description will discuss an embodiment of a content display device in accordance with the present invention, with reference to FIGS. 1 through 22.

(Content Display Device)

According to Embodiment 1, the content display device is configured to display, on a screen, a part of a bookshelf object which (i) is provided in a virtual three dimensional space and (ii) has a rectangular parallelepiped shape with four shelf surfaces. On each of the shelf surfaces of the bookshelf object, thumbnail images (contents) of a plurality of electronic books are arranged in a grid pattern. Note that an order in which the thumbnail images are arranged is determined in advance. In a case where a user selects a thumbnail image corresponding to a book, which the user intends to read, out of the thumbnail images by, for example, tapping a display screen including a touch panel, contents of the electronic book is displayed on the screen so that the user can read the electronic book. A concrete configuration of the content display device will be described later.

(Bookshelf Object)

First, the following description will discuss the bookshelf object which is displayed on the display screen.

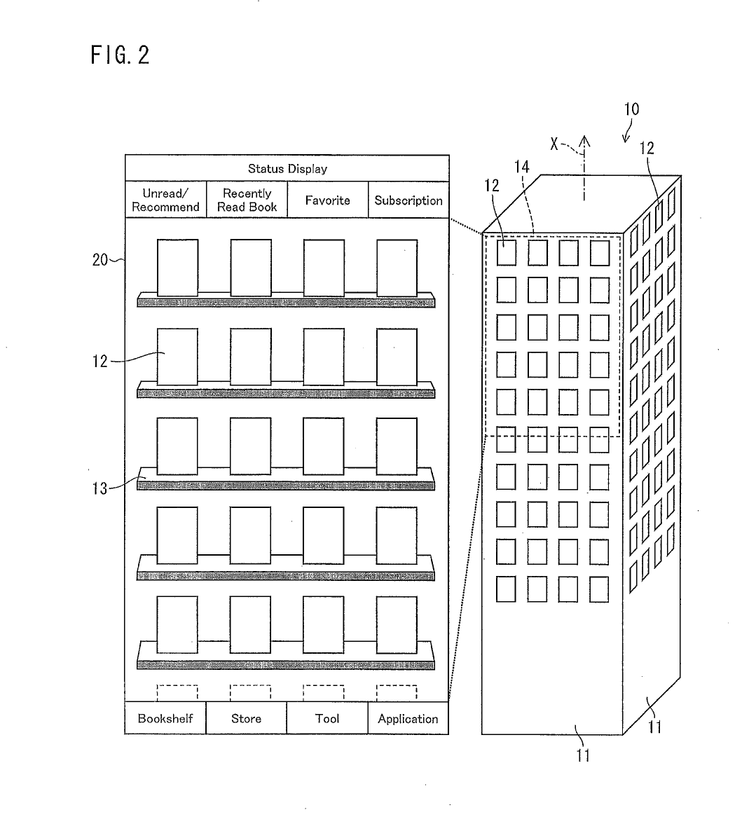

FIG. 2 is a view illustrating (i) the bookshelf object having a rectangular parallelepiped shape with the four shelf surfaces and (ii) a screen of the content display device on which screen a part of the bookshelf object is displayed. A right-side part of FIG. 2 illustrates a bookshelf object 10, and a left-side part of FIG. 2 illustrates a screen 20 of the content display device on which screen 20 a part of the bookshelf object 10 is displayed. In FIG. 2, an area 14 indicated by a dotted-line frame is an area of the bookshelf object 10 which area is actually displayed on the screen 20.

As illustrated in FIG. 2, the bookshelf object 10 is configured to have four shelf surfaces 11. Each of the shelf surfaces 11 has a plurality of shelves. On each of the shelves, thumbnail images (contents) 12 of respective of a plurality of electronic books are displayed as if the thumbnail images 12 are placed on the shelf. In a case where the user carries out a selection operation, such as a tapping operation, with respect to any of the thumbnail images 12 on the display screen, the user can read an electronic book corresponding to the selected thumbnail image 12. The four shelf surfaces 11 are assigned with respective different categories, and thumbnail images 12 of electronic books, which belong to a category, are arranged on one of the shelf surfaces 11 which one is assigned with the category to which the electronic books belong. The categories assigned to the shelf surfaces 11 are not limited to particular ones. In Embodiment 1, categories of “unread/recommend”, “recently read book”, “favorite”, and “subscription” are assigned to the four shelf surfaces 11, respectively. According to Embodiment 1, the bookshelf object 10 is made up of the four shelf surfaces. Note, however, that Embodiment 1 is not limited to this. Therefore, it is possible to provide more shelf surfaces in accordance with the number of categories.

The number of shelves 13 provided in each shelf surface 11 is not limited to a particular number. Moreover, the number of thumbnail images 12 displayed on each shelf 13 is not limited to a particular number. Therefore, such numbers can be determined as appropriate in accordance with performance of the content display device. According to Embodiment 1, successive five shelves 13 out of the shelves 13 are displayed in a normal state.

Thumbnail images 12 displayed on each of the shelves 13, i.e., electronic books arranged on the shelf surface 11 can be changed as appropriate by a user's operation.

(Displaying Bookshelf Object)

The following description will discuss how the bookshelf object 10 is displayed on the screen 20 of the content display device.

The bookshelf object 10 is to be displayed in two kinds of displaying modes, i.e., a normal mode and an active mode. In each of the normal mode and the active mode, the bookshelf object 10 is viewed from a virtual viewpoint which is located in a direction perpendicular to a central axis X of the bookshelf object 10. In this specification, a surface that faces the viewpoint is referred to as “front surface”. According to the configuration, a part of a front surface of the bookshelf object 10 is to be displayed on the screen 20 of the content display device.

In the normal mode, when no operation is carried out, only a shelf surface 11 in the front surface is displayed, and other shelf surfaces 11, which are adjacent to the front shelf surface 11, are not displayed. In a case where no operation is carried out with respect to the bookshelf object 10, only shelves 13 and thumbnail images 12 on the bookshelf object 10 are displayed on the screen 20.

Meanwhile, in the active mode, the shelf surface 11 in the front surface and the adjacent shelf surfaces 11 are displayed when no operation is carried out. In the active mode, the bookshelf object 10 is displayed as if being viewed from a viewpoint located farther than that of the normal mode. Note that, instead of displaying the adjacent shelf surfaces 11, a following shelf surface 11 can be displayed. In the active mode, opacities of the shelf surfaces 11 are decreased in order to display (i) the right and left shelf surfaces 11 adjacent to the shelf surface 11 in the front surface and (ii) thumbnail images on the right and left shelf surfaces 11. In the active mode, therefore, the user can recognize, more intuitively, that the bookshelf object 10 is a rectangular parallelepiped which is placed in the virtual three dimensional space. Note that, in this specification, a state in which the opacity is neither 100% nor 0% is referred to as “translucent”. In Embodiment 1, a surface opposite to the front surface is not displayed. Note, however, that the surface opposite to the front surface can be displayed by decreasing the opacity (i.e., increasing the transparency).

The normal mode and the active mode can be switched by an input operation carried out by the user.

The following description will discuss a display screen in the normal mode.

FIG. 1 is a view illustrating contents displayed on the screen 20 in the normal mode. As illustrated in a left-side part of FIG. 1, a plurality of thumbnail images 12 are displayed on the screen 20 in an order of arrangement determined in advance. Thumbnail IDs, which indicate an order in which the thumbnail images 12 are arranged, are allocated to the respective thumbnail images 12 in an order from upper left. In FIG. 1, thumbnail IDs of 1 through 20 are allocated to the respective thumbnail images 12. In Embodiment 1, an image in which 4 columns×5 rows of thumbnail images 12 are displayed on the screen 20 (see the left-side part of FIG. 1) is referred to as “normal display image”, and the screen 20 on which the normal display image is displayed is referred to as “normal display screen 201”.

In a case where the user specifies a thumbnail image 12 having a thumbnail ID of 15 on the normal display screen 201, a displayed state is changed to a state in which the shelves 13 are not displayed and only the thumbnail images 12 are displayed. When the thumbnail image 12 is scaled up during the state, the thumbnail images 12 are displayed in an arrangement of 3 columns×4 rows on the screen 20 as illustrated in a right-side part of FIG. 1. Note that an image in which the thumbnail images 12 are arranged in 3 columns×4 rows on the screen 20 is referred to as “first scaled-up image”, and the screen 20 on which the first scaled-up image is displayed is referred to as “first scaled-up screen 202”.

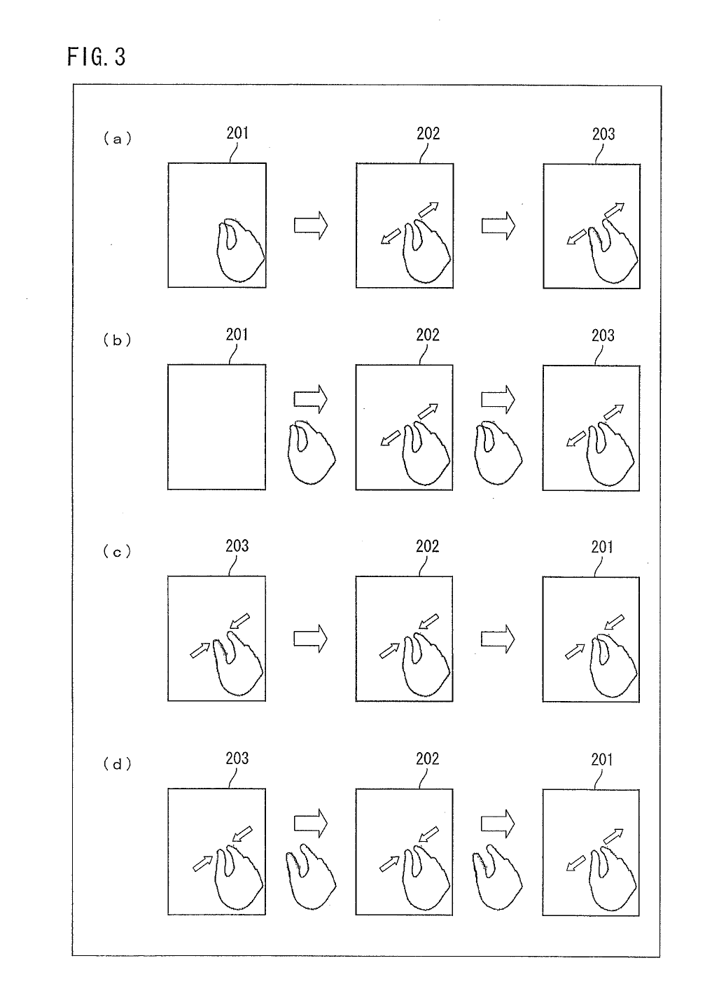

The following description will discuss how fingers are moved in this case, with reference to FIG. 3. When two fingers are gradually moved apart from each other (i.e., pinch-out) on the normal display screen 201 (see (a) of FIG. 3), the normal display screen 201 is changed to the first scaled-up screen 202 on which the thumbnail images 12 are displayed which have been scaled up from those displayed on the normal display screen 201. Moreover, when the two fingers are gradually moved further apart from each other, the thumbnail images 12 on the first scaled-up screen 202 are further scaled up so that an image, in which the thumbnail images 12 are arranged in 2 columns×3 rows, is displayed on the screen 20 of the content display device. Note that the image in which the thumbnail images 12 are arranged in 2 columns×3 rows on the screen 20 is referred to as “second scaled-up image”, and the screen 20 on which the second scaled-up image is displayed is referred to as “second scaled-up screen 203”.

Note that the operation for changing to the second scaled-up screen 203 is not limited to the operation in which the two fingers are gradually moved apart from each other on the normal display screen 201 as illustrated in (a) of FIG. 3. Alternatively, the screen 20 of the content display device can be changed to the second scaled-up screen 203 by carrying out the following operation: that is, two fingers are gradually moved apart from each other on the normal display screen 201 until the screen 20 of the content display device is changed to the first scaled-up screen 202, and then the fingers are once released from the first scaled-up screen 202. Subsequently, the two fingers are closed, and then the fingers are gradually moved apart from each other again on the first scaled-up screen 202 (see (b) of FIG. 3). When the user carries out such an operation, the screen 20 of the content display device is changed to the second scaled-up screen 203.

In order to change the screen 20 of the content display device from the second scaled-up screen 203 to the normal display screen 201, two fingers, which are apart from each other, are gradually moved closer to each other (i.e., pinch-in) on the second scaled-up screen 203 (see (c) of FIG. 3). By carrying out this operation, the screen 20 of the content display device is changed from the second scaled-up screen 203 to the first scaled-up screen 202. Moreover, when the user gradually moves the two fingers further closer to each other, the screen 20 of the content display device is changed to the normal display screen 201.

Note that the operation for changing to the normal display screen 201 is not limited to the operation in which the two fingers are gradually moved closer to each other on the second scaled-up screen 203 as illustrated in (c) of FIG. 3. Alternatively, the screen 20 of the content display device can be changed to the normal display screen 201 by carrying out the following operation: that is, two fingers are gradually moved closer to each other on the second scaled-up screen 203 until the screen 20 of the content display device is changed to the first scaled-up screen 202, and then the fingers are once released from the first scaled-up screen 202. Subsequently, the two fingers are opened, and then the fingers are gradually moved closer to each other again on the first scaled-up screen 202 (see (d) of FIG. 3). When the user carries out such an operation, the screen 20 of the content display device is changed to the normal display screen 201.

Note that the thumbnail images 12 which are arranged in 4 columns×5 rows on the normal display screen 201 are assumed to be displayed at respective locations which have been determined in advance. Similarly, (i) the thumbnail images 12 arranged in 3 columns×4 rows on the first scaled-up screen 202 and (ii) the thumbnail images 12 arranged in 2 columns×3 rows on the second scaled-up screen 203 are also displayed at respective locations which have been determined in advance.

Note that, hereinafter, a thumbnail image 12 having a thumbnail ID of N (N is a natural number) is referred to as “thumbnail (N)”.

(Method for Displaying Thumbnail Image 12)

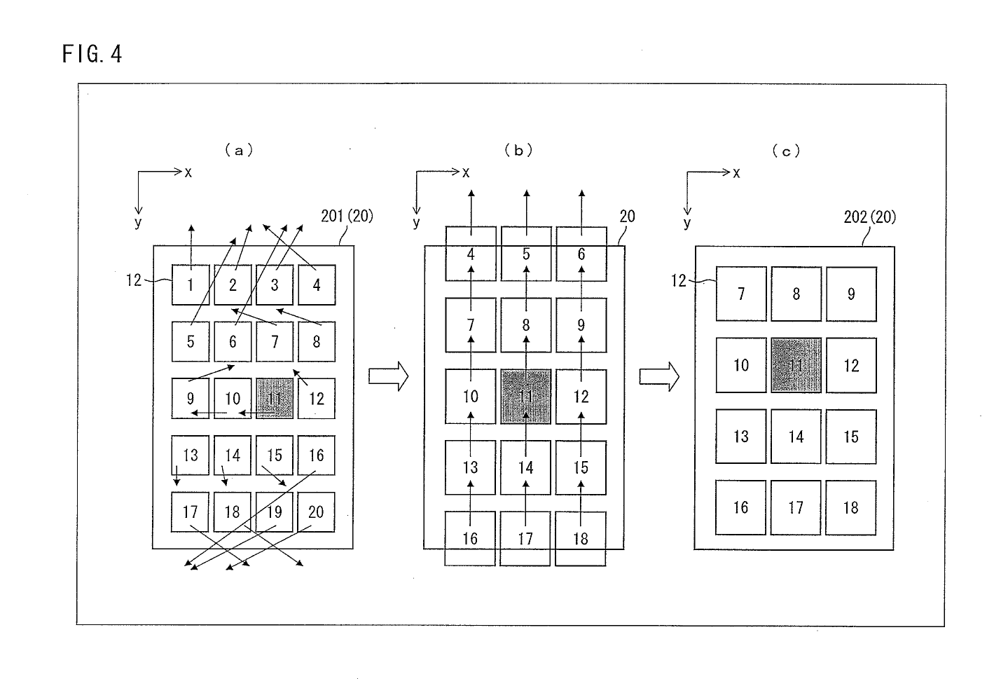

The following description will discuss, with reference to FIG. 4, a method in which the screen 20 displays the first scaled-up image (i.e., the screen 20 is changed to the first scaled-up screen 202) when the user specifies a thumbnail image 12 out of a plurality of thumbnail images 12 displayed on the normal display screen 201 and carries out a pinch-out operation with respect to the specified thumbnail image 12.

FIG. 4 illustrates the first scaled-up screen 202 which is displayed when a thumbnail image 12 having a thumbnail ID of 11 is specified and subjected to pinch-out on the normal display screen 201.

As illustrated in (a) of FIG. 4, when a thumbnail (11) is specified and subjected to pinch-out by the user on the normal display screen 201, the thumbnail (11) is scaled up while being centered on a center point of the thumbnail (11). Further, in the first scaled-up screen 202, the thumbnail (11) is moved in an x-axis direction of a location at which the thumbnail (11) is displayed. According to Embodiment 1, the thumbnail (11) is displayed at a center of the screen 20 as illustrated in (b) of FIG. 4, and therefore the thumbnail (11) is moved in a negative direction of the x-axis as indicated by an arrow in (a) of FIG. 4.

Once a location to which the thumbnail (11) is to be moved is determined, an arrangement of thumbnails (1) through (10) and thumbnails (12) through (20) is changed so that the thumbnail images 12 are arranged in 3 columns on the first scaled-up screen 202. The thumbnail images 12 are moved in directions indicated by arrows in (a) of FIG. 4, while being scaled up, so as to be displayed at respective locations in the changed arrangement.

After the thumbnail images 12 are moved, the plurality of thumbnail images 12 are displayed at respective changed locations on the screen 20 (see (b) of FIG. 4). In this case, the plurality of thumbnail images 12 are arranged in 3 columns×5 rows on the screen 20, and the thumbnails (4) through (6) and the thumbnails (16) through (18) are merely partially displayed. In order to deal with this, the plurality of thumbnail images 12 as illustrated in (b) of FIG. 4 are moved in a direction (i.e., in a negative direction of a y-axis) as indicated by arrows in (b) of FIG. 4 so that the plurality of thumbnail images 12 are displayed at respective locations which have been determined in advance (this process is referred to as “fitting”). This causes the screen 20 to be changed to the first scaled-up screen 202 in which the plurality of thumbnail images 12 are displayed in an arrangement of 3 columns×4 rows (see (c) of FIG. 4).

(Configuration of Content Display Device)

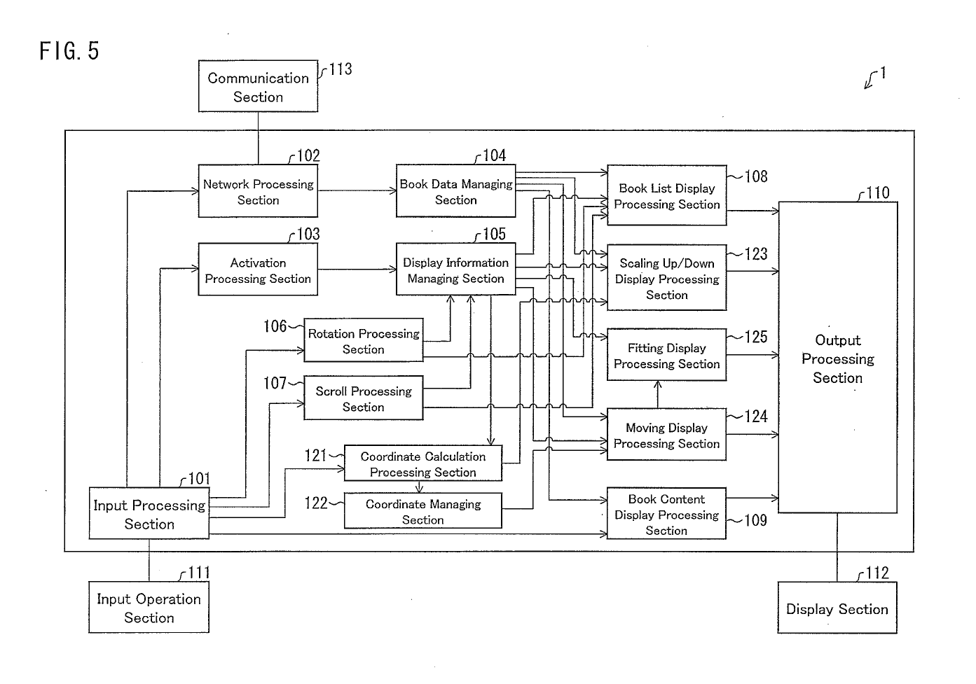

The following description will discuss, with reference to FIG. 5, a configuration and a function of the content display device for achieving the display as above described. FIG. 5 is a block diagram illustrating a configuration of main parts of the content display device 1 in accordance with an embodiment of the present invention.

As illustrated in FIG. 5, the content display device 1 includes an input processing section 101, a network processing section 102, an activation processing section 103, a book data managing section 104, a display information managing section 105, a rotation processing section 106, a scroll processing section 107, a book list display processing section 108, a book content display processing section 109, an output processing section 110, an input operation section (input means) 111, a display section (display means) 112, a communication section 113, a coordinate calculation processing section (changing means, moving means) 121, a coordinate managing section 122, a scaling up/down display processing section (changing means) 123, a moving display processing section (moving means) 124, and a fitting display processing section 125.

The input processing section 101 (i) obtains input operation information detected by the input operation section 111 and (ii) gives, based on the information, an instruction on carrying out processes to the rotation processing section 106, the scroll processing section 107, and the coordinate calculation processing section 121. Alternatively, the input processing section 101 gives, to the book content display processing section 109, an instruction on carrying out a process.

The network processing section 102 obtains book data, which is content data, from a server on a network via the communication section 113. The book data includes a book image, book information, and a book content. According to Embodiment 1, the book data is stored in the content display device 1. Note, however, that Embodiment 1 is not limited to this, and a configuration (i.e., a cloud system) can be employed in which the book data is obtained as needed from the server.

The book data managing section 104 (i) causes a storage device to store book data obtained by the network processing section 102 and (ii) manages the obtained book data. Moreover, the book data managing section 104 sends book data in response to requests from the book list display processing section 108 and the book content display processing section 109.

When an activation operation is carried out with respect to the content display device 1, the activation processing section 103 gives, to the display information managing section 105, an instruction on carrying out a process so that the display section 112 displays an image.

The display information managing section 105 manages an image to be displayed by the display section 112. In a case where an activation process is carried out, the display information managing section 105 gives, to the book list display processing section 108, an instruction on generating an image to be displayed. Moreover, when the rotation or scrolling is carried out, the display information managing section 105 causes the storage device such as a memory to store (i) location information indicative of locations of shelves on the front surface which locations have been changed by rotation or scrolling, (ii) scroll location information indicative of locations changed by scrolling, (iii) a scaled-up/scale-down value, (iv) book information of a displayed book content, (v) page information of a displayed book, and (vi) information indicative of whether a list displayed on a subscription shelf is a list of latest issues or a list of back numbers. Moreover, the display information managing section 105 causes the storage device such as a memory to store (i) thumbnail IDs corresponding to thumbnail images 12 of respective books and (ii) location information and sizes of the plurality of thumbnail images 12 displayed on the normal display screen 201, first scaled-up screen 202, and the second scaled-up screen 203.

When (i) the input operation section 111 has detected an input operation for rotating the bookshelf object 10 displayed on the display section 112 and (ii) the input processing section 101 has accepted operation information of the input operation, the rotation processing section 106 carries out, based on the operation information, processes with respect to an animation and an image to be displayed on the display section 112.

Similarly, when (i) the input operation section 111 has detected an input operation for scrolling the shelf surface 11 displayed on the display section 112 and (ii) the input processing section 101 has accepted operation information of the input operation, the scroll processing section 107 carries out, based on the operation information, processes with respect to an animation and an image to be displayed on the display section 112.

The book list display processing section 108 (i) obtains, from the book data managing section 104, book data to be displayed, (ii) obtains, from the display information managing section 105, an image to be displayed, (iii) obtains information which has been processed by the rotation processing section 106 or the scroll processing section 107, (iv) generates an image and an animation which are used when the display section 112 displays a book list, and then (v) sends the image and the animation to the output processing section 110.

The book content display processing section 109 (i) accepts, from the input processing section 101, information on a book selected by the user via the input operation section 111, (ii) obtains, based on the information, book data of the selected book from the book data managing section 104, and then (iii) sends data which contains contents of the book to the output processing section 110. In a case where a thumbnail image 12 of a book is tapped and the input processing section 101 accepts the input operation, the operation information is then sent to the book content display processing section 109 so that the book content display processing section 109 carries out a process for displaying contents (texts) of the book. In a case where the input processing section 101 accepts a long-tapping (i.e., pressing-and-holding) input operation and operation information of the input operation is sent to the book content display processing section 109, the book content display processing section 109 carries out a process for displaying book information such as a title, a publisher, an author, commentary on the book, and a published date.

The output processing section 110 receives a content to be displayed, which content has been generated by and sent from any of the book list display processing section 108, the book content display processing section 109, the scaling up/down display processing section 123, the moving display processing section 124, and the fitting display processing section 125. Then, the output processing section 110 (i) converts the content into data for being displayed and (ii) causes the display section 112 to display the data.

In a case where (i) any of thumbnail images 12 displayed on the display section 112 has been specified, then (ii) the input operation section 111 has detected an instruction on changing a display size of the thumbnail image 12, and then (iii) the input processing section 101 has accepted operation information (instruction information) of the instruction, the coordinate calculation processing section 121 calculates, based on information of the thumbnail image 12 and the operation information, coordinates of the thumbnail image 12 which has been scaled up or scaled down. Here, the instruction on changing a display size indicates, for example, a scaling-up instruction (pinch-out) or a scaling-down instruction (pinch-in) with respect to the thumbnail image 12.

The coordinate managing section 122 (i) causes a storage device to store coordinates calculated by the coordinate calculation processing section 121 and (ii) manages the coordinates. Moreover, the coordinate managing section 122 sends the coordinates in response to a request from the moving display processing section 124.

The scaling up/down display processing section 123 (i) obtains, from the book data managing section 104, book data to be displayed, (ii) obtains, from the display information managing section 105, an image to be displayed, (iii) obtains information which has been processed by the coordinate calculation processing section 121, (iv) generates an image and an animation which are used when the display section 112 displays a scaled-up book list, and (v) sends the image and the animation to the output processing section 110.

The moving display processing section 124 (i) obtains, from the book data managing section 104, book data to be displayed, (ii) obtains, from the display information managing section 105, an image to be displayed, (iii) obtains coordinates of an image to be displayed from the coordinate managing section 122, (iv) generates an image and an animation which are used when the display section 112 displays a book list in which an arrangement has been changed, and (v) sends the image and the animation to the output processing section 110. The moving display processing section 124 sends, to the fitting display processing section 125, (i) book data of books in a book list in which an arrangement of the books has been changed, (ii) images to be displayed, (iii) thumbnail IDs of the images, and (iv) display locations of the images.

The fitting display processing section 125 (i) obtains, from the moving display processing section 124, (a) book data of books in a book list in which an arrangement of the books has been changed, (b) images to be displayed, (c) thumbnail IDs of the images, and (d) display locations of the images, (ii) obtains location information of thumbnail images 12 from the display information managing section 105, (iii) generates an image which is used when the display section 112 displays a book list which has been subjected to fitting, and (iv) sends the image to the output processing section 110.

When the content display device 1 is activated, each of the processing sections obtains, within its functional range, a type of a shelf surface 11, thumbnail images 12 of books, book data such as book information, a type of a shelf surface 11 which was previously displayed, and display information such as a scrolled location of the previously displayed shelf surface 11, which are stored in the memory. Except when the content display device 1 is activated, i.e., when an operation process is carried out, thumbnail images 12 of books, which are to be displayed in a list, are obtained from display information and book data, and then the thumbnail images 12 are converted into texture data for use in virtual three dimensional display. From the display information, parameters of a viewpoint and the like are calculated for carrying out the virtual three dimensional display. A three dimensional arithmetic operation is carried out with respect to the book data by a three dimensional process, and the book data is displayed by a display process. When a book is read, a book content of book data is obtained, and the book content is two-dimensionally displayed. When a book is purchased, book data is purchased via a network, and the book data is managed by the book data managing section. In a case where a thumbnail image 12 of a purchased book is to be displayed, the thumbnail image 12 is displayed by the book list display processing section in a virtual three dimensional display.

Note that a person skilled in the art, who understands the display contents, which have been described as above, on the screen 20 of the content display device 1, can realize (i) display of the bookshelf object 10 and the shelf surfaces 11, (ii) rotation of the bookshelf object 10 and display of such rotation, and (iii) scrolling of the shelf surface 11 and display of such scrolling, by applying a known technique such as an open graphics library (open GL). Under the circumstances, concrete descriptions are omitted here as to how data is processed by the processing sections and managed by the managing sections in order to carry out the display.

The input operation section 111 detects an input made by pressing on the screen 20 by the user. The input operation section 111 is configured by, for example, a touch panel. This allows a user to intuitively operate the content display device. That is, even a user who operates the content display device for the first time and a user who is unaccustomed to operate apparatuses can operate the content display device without difficulty.

The display section 112 can be configured by a display device which includes, for example, a liquid crystal panel.

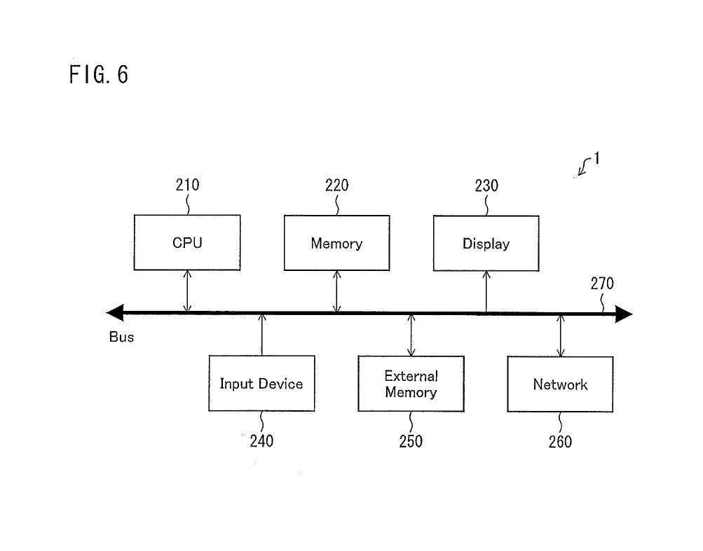

Each of the processing sections and the managing sections can be configured by, for example, a computer (electronic computer). FIG. 6 is a block diagram illustrating an example of a hardware configuration of the content display device 1 which is achieved by the use of a computer.

The content display device 1 includes a central processing unit (CPU) 210, an internal storage device (memory) 220, a display 230, and an input device 240 which are connected with each other via a bus 270, and the content display device 1 can be connected with (i) an external storage device (external memory) 250 via an input/output interface and (ii) an external network 260 such as the Internet via a network communication device (see FIG. 6).

The memory 220 stores (i) programs for causing the computer to serve as the processing sections and the managing sections and (ii) obtained electronic book data.

The input device 240 is means for accepting an input operation carried out by a user. The input device 240 is configured by, for example, a track ball or a touch panel which is provided on the display.

The book data can be obtained via the external memory 250 and the communications network 260.

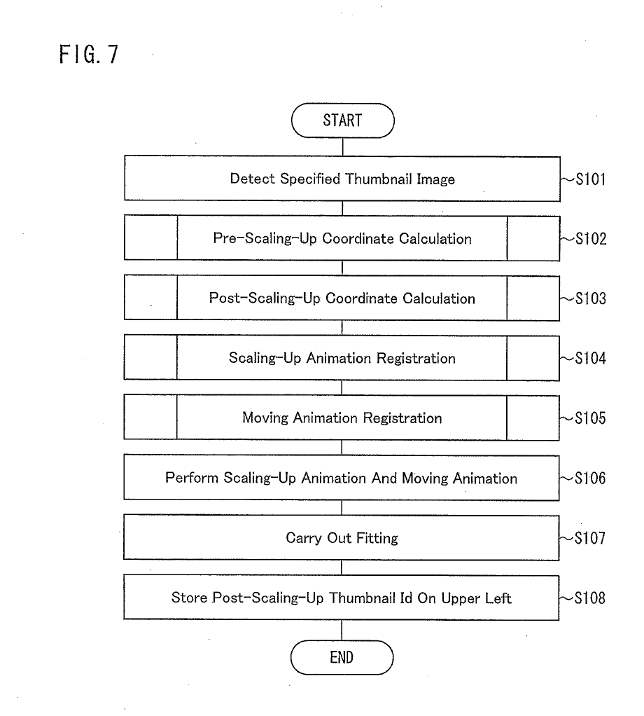

(Process for Scaling up Thumbnail Image 12) Next, the following description will discuss a scaling-up process on the thumbnail image 12, with reference to FIGS. 7 through 11. FIG. 7 is a flowchart for explaining a scaling-up process in which a thumbnail image 12 is specified and subjected to pinch-out by the user.

The input operation section 111 detects that the user has (i) specified any of a plurality of thumbnail images 12 displayed on the screen 20 of the display section 112 and (ii) carried out pinch-out with respect to the thumbnail image 12 (specified content). The input processing section 101 accepts operation information of the input operation (step S101, hereinafter simply referred to as S101) (input step).

Subsequently, the coordinate calculation processing section 121 calculates coordinates of (i) the specified thumbnail image 12 which has not been scaled up yet and (ii) the other of the plurality of thumbnail images 12 which are displayed on the screen 20 and have not been scaled up yet (S102, a pre-scaling-up coordinate calculation process). Moreover, the coordinate calculation processing section 121 calculates coordinates of (i) the specified thumbnail image 12 which has been scaled up and (ii) the other of the plurality of thumbnail images which are displayed on the screen 20 and have been scaled up (S103, a post-scaling-up coordinate calculation process).

Next, the scaling up/down display processing section 123 (i) registers a size (thumbnail size) of thumbnail images 12 which have been scaled up and (ii) carries out a preprocess for generating an image and a scaling-up animation which are used when the display section 112 displays a scaled up book list (S104, a scaling-up animation registration process). Then, the moving display processing section 124 registers coordinates of thumbnail images 12 which have been moved, and carries out a preprocess for generating (i) an image used when the book list is displayed on the display section 112 and (ii) a moving animation which is used when the thumbnail images 12 are moved to post-scaling-up coordinates (S105, a moving animation registration process).

Subsequently, the scaling up/down display processing section 123 generates an image and a scaling-up animation which are used when the display section 112 displays a scaled up book list. Then, the scaling up/down display processing section 123 sends, to the output processing section 110, the image and the scaling-up animation which have been generated. The output processing section 110 receives display contents sent from the scaling up/down display processing section 123, and causes the scaling-up animation and the image to be displayed (a changing step, a changing process). The moving display processing section 124 generates an image and a scaling-up animation which are used when the display section 112 displays a book list. Then, the moving display processing section 124 sends, to the output processing section 110, the image and the moving animation which have been generated.

The output processing section 110 receives display contents sent from the moving display processing section 124, and causes the moving animation and the image to be displayed (a moving step, a moving process) (S106).

Thereafter, the fitting display processing section 125 generates an image in which the plurality of thumbnail images 12 displayed on the screen 20 have been moved so that Y coordinates of the respective plurality of thumbnail images 12 displayed on the screen 20 match Y coordinates calculated at S103. Then, the fitting display processing section 125 sends the image to the output processing section 110. The output processing section 110 receives display contents sent from the fitting display processing section 125, and causes the image to be displayed (S107).

The coordinate managing section 122 causes the storage device to store a thumbnail ID of a thumbnail image 12 which is displayed on the upper left of the screen 20 after being scaled up (S108). Note that the thumbnail ID is preferably stored in the storage device for each shelf 13. Moreover, a thumbnail ID of a thumbnail image 12, which is displayed on the upper left of the screen 20 after a process such as scrolling is carried out, is preferably stored in the storage device.

(Pre-Scaling-Up Coordinate Calculation Process)

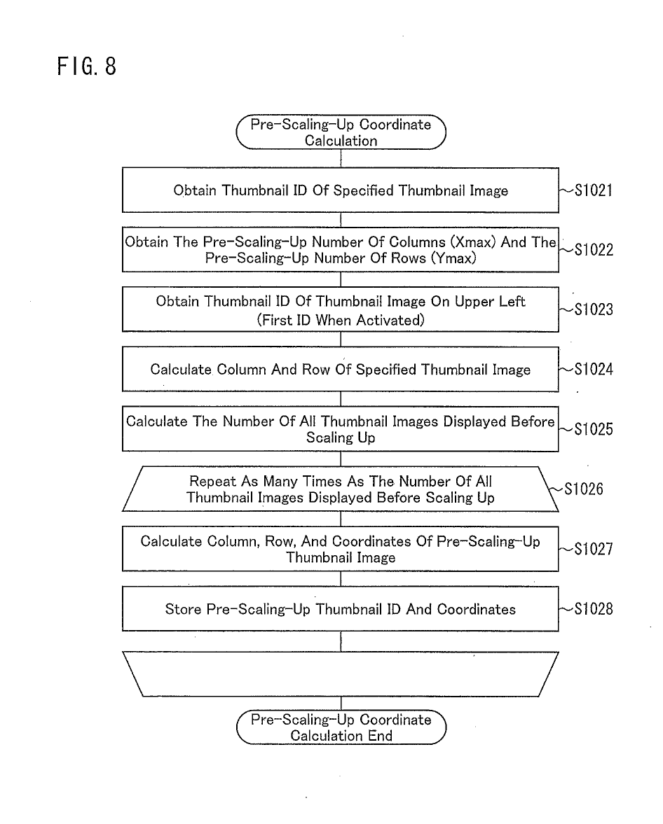

Next, a process at S102 for calculating pre-scaling-up coordinates of a thumbnail image 12 is described below with reference to FIG. 8. FIG. 8 is a flowchart illustrating an example flow of the pre-scaling-up coordinate calculation process in FIG. 7.

The coordinate calculation processing section 121 obtains, from the input processing section 101, a thumbnail ID of the specified thumbnail image 12 (S1021). Next, the coordinate calculation processing section 121 obtains the number of columns (Xmax) and the number of rows (Ymax) of thumbnail images 12 displayed on the screen 20 in this case (S1022). Note here that the pre-scaling-up number of columns is indicated by “Xmax(p)” and the pre-scaling-up number of rows is indicated by “Ymax(p)”.

Subsequently, the coordinate calculation processing section 121 obtains a thumbnail ID of a thumbnail image 12 displayed on the upper left of the screen 20 in this case. Note here that the thumbnail ID of the thumbnail image 12 located on the upper left of the screen 20 is the thumbnail ID stored in advance in the storage device at S108. Note that the thumbnail image 12 located on the upper left of the screen 20 has the first ID (e.g., a thumbnail ID of 1) when the content display device 1 is activated (S1023).

Then, the coordinate calculation processing section 121 calculates in what row (Yn(p)) of what column (Xn(p)) the specified thumbnail image 12 is displayed on the screen 20, based on the following equations (1) and (2):

Xn=(ID−1)mod(Xmax) (1)

Yn=(ID−StartID)/(Xmax) (2)

where “ID” indicates the thumbnail ID of the specified thumbnail image 12, “StartID” indicates the thumbnail ID, obtained at S1023, of the thumbnail image 12 displayed on the upper left of the screen 20. In the equation (1), “mod” is an operator indicative of a remainder derived from the division by Xmax.

The coordinate calculation processing section 121 calculates, by substituting Xn=Xn(p), Yn=Yn(p), and Xmax=Xmax(p) for the equations (1) and (2), a column and a row in which the specified thumbnail image 12 is displayed on the screen 20 (S1024).

Next, the coordinate calculation processing section 121 calculates the number of thumbnail images 12 displayed on the screen 20 (S1025).

Subsequently, the coordinate calculation processing section 121 calculates (i) a thumbnail ID of each of the plurality of thumbnail images 12 displayed on the screen 20, (ii) a column (Xn) and a row (Yn) in each of which the each of the plurality of thumbnail images 12 is displayed on the screen 20, and (iii) coordinates (X, Y) of the each of the plurality of thumbnail images 12 on the screen 20 on which the plurality of thumbnail images 12 are displayed (S1027). Note that coordinates of a thumbnail image 12 on the screen 20 are coordinates of an upper left point of the thumbnail image 12. The coordinate managing section 122 causes the calculated coordinates to be stored in the storage device so that the calculated coordinates are associated with the thumbnail ID (S1028). S1027 and S1028 are carried out as many times as the number of the thumbnail images 12 which number has been calculated at S1025 (S1026).

(Post-Scaling-Up Coordinate Calculation Process)

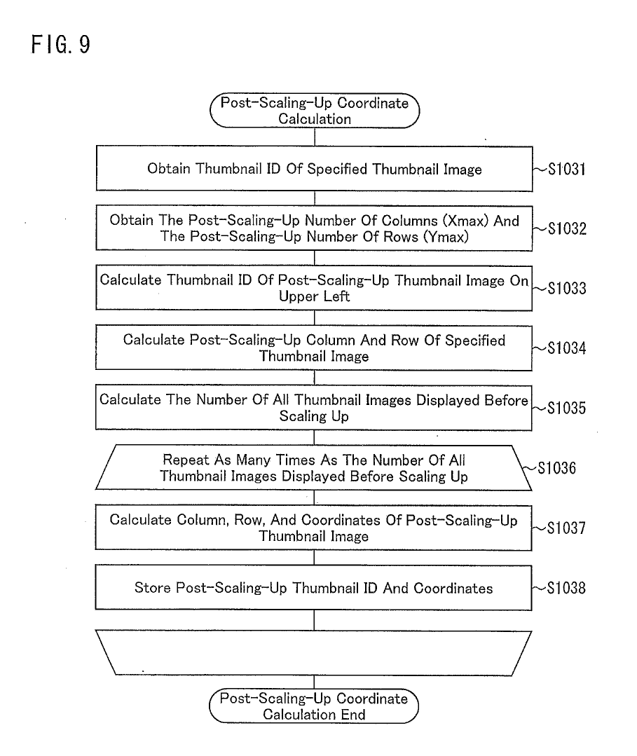

Next, a process at S103 for calculating post-scaling-up coordinates of a thumbnail image 12 is described below with reference to FIG. 9. FIG. 9 is a flowchart illustrating an example flow of the post-scaling-up coordinate calculation process in FIG. 7.

The coordinate calculation processing section 121 obtains, from the input processing section 101, a thumbnail ID of the specified thumbnail image 12 (S1031). Next, the coordinate calculation processing section 121 obtains the number of columns (Xmax) and the number of rows (Ymax) of thumbnail images 12 displayed on the screen 20 in this case (S1032). Note here that the post-scaling-up number of columns is indicated by “Xmax(f)” and the post-scaling-up number of rows is indicated by “Ymax(f)”.

Subsequently, the coordinate calculation processing section 121 obtains a thumbnail ID of a thumbnail image 12, located on the upper left of the screen 20, of a plurality of thumbnail images 12 displayed on the screen 20 after being scaled up. Note here that the thumbnail ID of the thumbnail image 12 located on the upper left of the screen 20 is the thumbnail ID stored in advance in the storage device at S108 (S1033).

Then, the coordinate calculation processing section 121 calculates in what row (Yn(f)) of what column (Xn(f)) the specified thumbnail image 12 is displayed on the screen 20, based on the equations (1) and (2): where “StartID” indicates the thumbnail ID, obtained at S1033, of the thumbnail image 12 displayed on the upper left of the screen 20. The coordinate calculation processing section 121 calculates, by substituting Xn=Xn(f), Yn=Yn(f), and Xmax=Xmax(f) for the equations (1) and (2), a column and a row in which the specified thumbnail image 12 is displayed on the screen 20 (S1034).

Next, the coordinate calculation processing section 121 calculates the number of the thumbnail images 12 displayed on the screen 20 (S1035).

Subsequently, the coordinate calculation processing section 121 calculates (i) a thumbnail ID of each of the plurality of thumbnail images 12 displayed on the screen 20 after being scaled up, (ii) a column (Xn) and a row (Yn) in which the each of the plurality of thumbnail images 12 is displayed on the screen 20, and (iii) coordinates (X, Y) of the each of the plurality of thumbnail images 12 on the screen 20 on which the plurality of thumbnail images 12 are displayed (S1037). The coordinate managing section 122 causes the calculated coordinates to be stored in the storage device so that the calculated coordinates are associated with the thumbnail ID (S1038). S1037 and S1038 are carried out as many times as the number of the thumbnail images 12 which number has been calculated at S1035 (S1036).

(Scaling-Up Animation Registration Process)

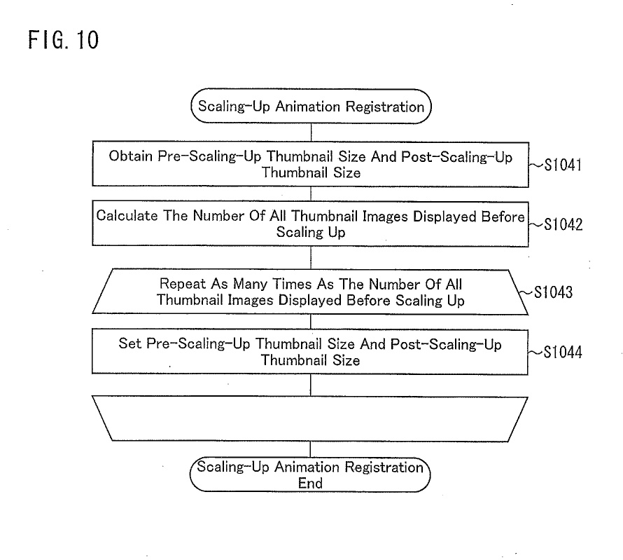

Next, a scaling-up animation registration process at S104 is described below with reference to FIG. 10. FIG. 10 is a flowchart illustrating an example flow of the scaling-up animation registration process in FIG. 7.

The scaling up/down display processing section 123 obtains, from the display information managing section 105, a pre-scaling-up thumbnail size and a post-scaling-up thumbnail size of the specified thumbnail image 12 (S1041). Subsequently, the scaling up/down display processing section 123 calculates the number of all the thumbnail images 12 displayed on the screen 20 before the thumbnail images 12 are scaled up (S1042).

Thereafter, the scaling up/down display processing section 123 sets a pre-scaling-up thumbnail size and a post-scaling-up thumbnail size for each of the thumbnail images 12 (S1044). S1044 is carried out as many times as the number of the thumbnail images 12 which number has been calculated at S1042 (S1043).

(Moving Animation Registration Process)

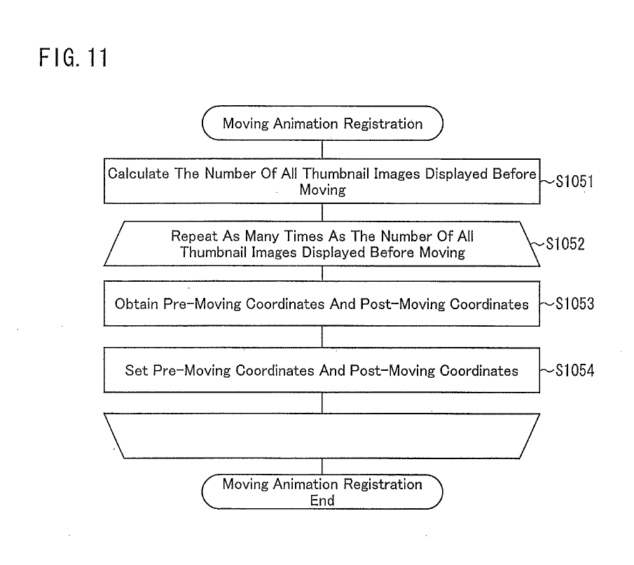

Next, a moving animation registration process at S105 is described below with reference to FIG. 11. FIG. 11 is a flowchart illustrating an example flow of the moving animation registration process in FIG. 7.

The moving display processing section 124 calculates the number of all the thumbnail images 12 which are displayed on the screen 20 before the thumbnail images 12 are moved (S1051). Thereafter, the moving display processing section 124 obtains, from the coordinate managing section 122, pre-moving coordinates and post-moving coordinates of a thumbnail image 12 (S1053), and sets the pre-moving coordinates and the post-moving coordinates for each of the thumbnail images 12 (S1054). S1053 and S1054 are carried out as many times as the number of the thumbnail images 12 which number has been calculated at S1051 (S1052).

(Another Example of Moving Process)

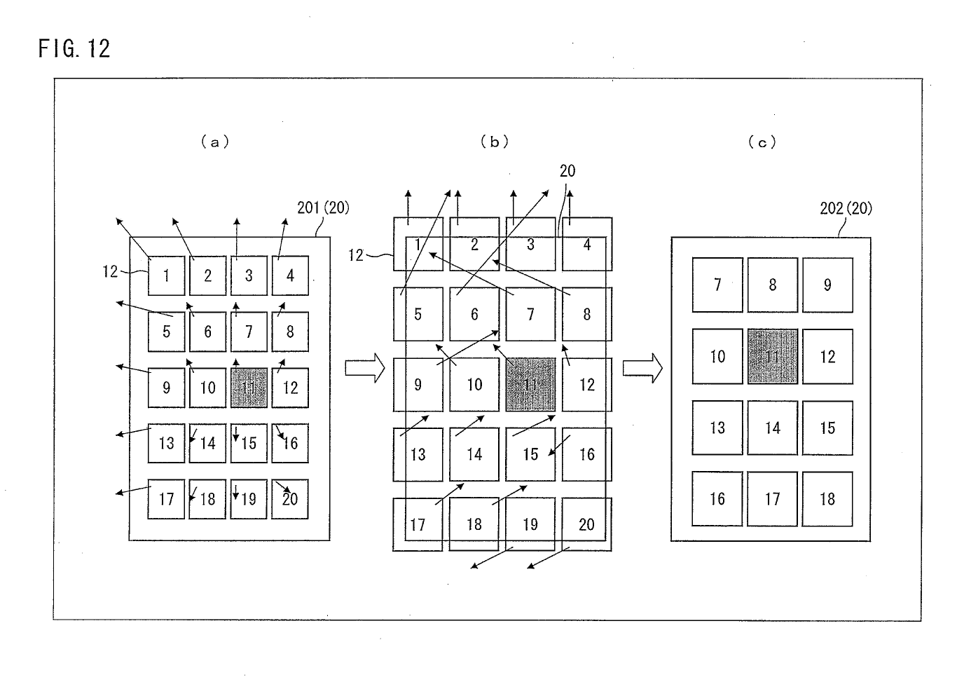

The following description will discuss another example of a moving process, with reference to FIG. 12. FIG. 12 is a view illustrating a state where a normal display screen 201 is changed to a first scaled-up screen 202 when a scaling-up process is carried out on the normal display screen 201. When a thumbnail image 12 (thumbnail (11)) having a thumbnail ID of 11 is specified and subjected to pinch-out (see (a) of FIG. 12), the thumbnail images 12 are scaled up while being centered on a center point of the thumbnail (11) (see (b) of FIG. 12). In a scaling-up animation performed in the changing step, thumbnail images 12 are displayed which are being scaled up in directions indicated by arrows in (a) of FIG. 12. Subsequently, in a screen 20 (first scaled-up screen 202) obtained after the thumbnail (11) is scaled up, the moving display processing section 124 moves all thumbnail images 12, which are displayed on the normal display screen 201, to predetermined post-moving coordinates. Note that, in the moving animation performed in the moving step, thumbnail images 12 are scaled up in directions indicated by arrows in (b) of FIG. 12. After the moving step, the thumbnail images 12 are displayed as illustrated in (c) of FIG. 12. As such, by thus moving the thumbnail images 12 to the post-moving coordinates determined in advance, it is not necessary to carry out the fitting process of S107.

(Regarding Fitting)

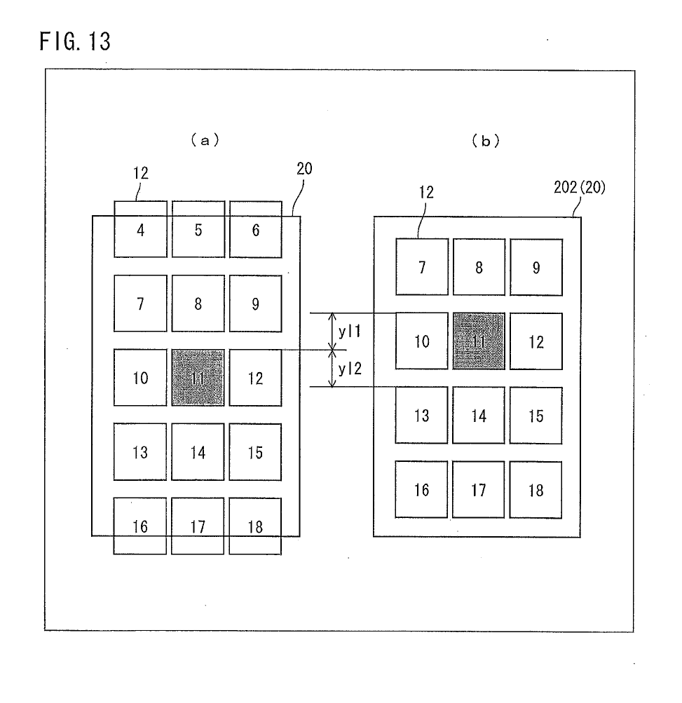

The following description will further discuss a fitting, with reference to FIG. 13. (a) of FIG. 13 illustrates a screen 20 in which (i) a plurality of thumbnail images 12 have been moved by the moving display processing section 124 from a state illustrated in (b) of FIG. 12 but (ii) a fitting has not been carried out yet. (b) of FIG. 13 illustrates the screen 20 (first scaled-up screen 202) in which the fitting has been carried out. The thumbnail (11) is located substantially at the center of the screen 20 (see (a) of FIG. 13).

Here, the fitting display processing section 125 causes the thumbnail images 12 to be arranged in 3 columns×4 rows on the first scaled-up screen 202 by moving up or down the thumbnail images 12 displayed on the screen 20 illustrated in (a) of FIG. 13. In this case, the fitting display processing section 125 obtains, from the display information managing section 105, Y coordinates of the respective rows on the screen 20. Moreover, the fitting display processing section 125 calculates a distance based on (i) a Y coordinate of the thumbnail (11) which Y coordinate has been sent from the moving display processing section 124 and (ii) the Y coordinates of the respective rows which Y coordinates have been obtained from the display information managing section 105. According to Embodiment 1, the thumbnail (11) is displayed substantially at the center of the screen 20 as illustrated in (a) of FIG. 13. Therefore, the fitting display processing section 125 calculates (i) a distance y11 between the Y coordinate of the thumbnail (11) and a Y coordinate of the second row and (ii) a distance y12 between the Y coordinate of the thumbnail (11) and a Y coordinate of the third row.

As illustrated in (a) of FIG. 13, the location at which the thumbnail (11) is currently displayed is closer to the second row (i.e., y11<y12), and therefore the fitting display processing section 125 generates an image (first scaled-up image) in which the plurality of thumbnail images 12 have been moved upward by y11 so that the thumbnail (11) is displayed in the second row (see (b) of FIG. 13).

(Location and Size of Thumbnail Image 12)

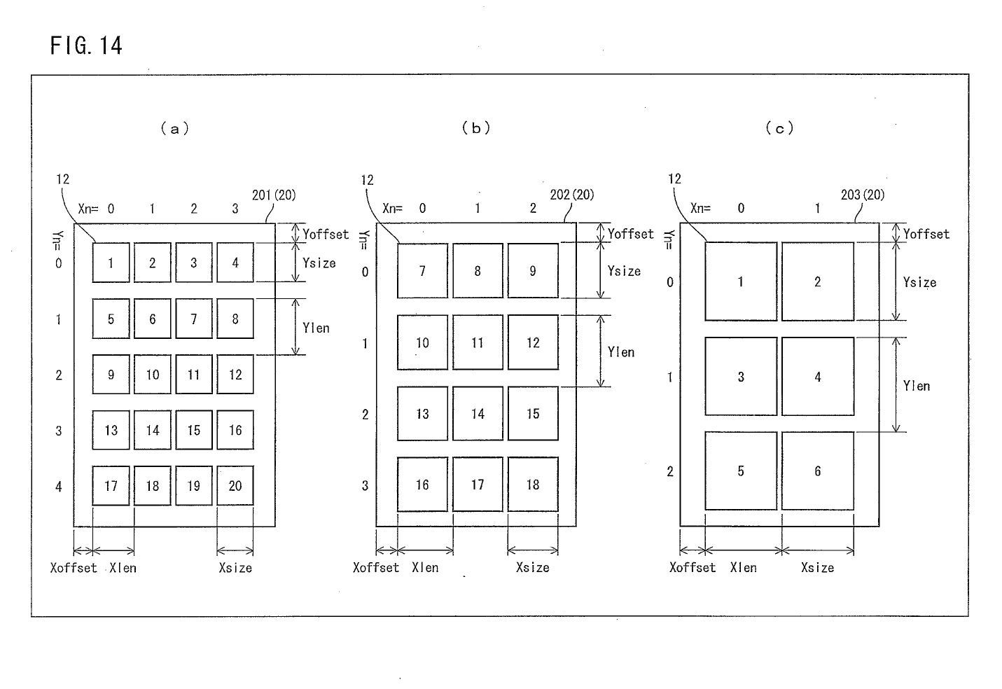

The following description will discuss, with reference to FIGS. 14 through 16, location information and sizes of a plurality of thumbnail images 12 displayed on the normal display screen 201, the first scaled-up screen 202, and the second scaled-up screen 203. The location information and the sizes are managed by the display information managing section 105.

FIG. 14 is a view illustrating locations and sizes of thumbnail images 12 displayed on the normal display screen 201, the first scaled-up screen 202, and the second scaled-up screen 203.

As illustrated in (a) through (c) of FIG. 14, a plurality of thumbnail images 12 are arranged in a matrix manner on each of the normal display screen 201, the first scaled-up screen 202, and the second scaled-up screen 203. The number of thumbnail images 12, which are displayed on the first scaled-up screen 202, is smaller than that of thumbnail images 12 displayed on the normal display screen 201. Moreover, the number of thumbnail images 12, which are displayed on the second scaled-up screen 203, is smaller than that of the thumbnail images 12 displayed on the first scaled-up screen 202.

As illustrated in (a) through (c) of FIG. 14, “Xsize” indicates a width of a thumbnail image 12, and “Ysize” indicates a height of a thumbnail image 12. “Xlen” indicates a length from a left edge of a certain thumbnail image 12 to a left edge of another thumbnail image 12 which is adjacent to the certain thumbnail image 12. “Ylen” indicates a length from an upper edge of a certain thumbnail image 12 to an upper edge of another thumbnail image 12 which is located immediately below the certain thumbnail image 12. “Xoffset” indicates a distance between a left edge of the screen 20 and a left edge of a leftmost thumbnail image 12 displayed on the screen 20. “Yoffset” indicates a distance between an upper edge of the screen 20 and an upper edge of an uppermost thumbnail image 12 displayed on the screen 20.

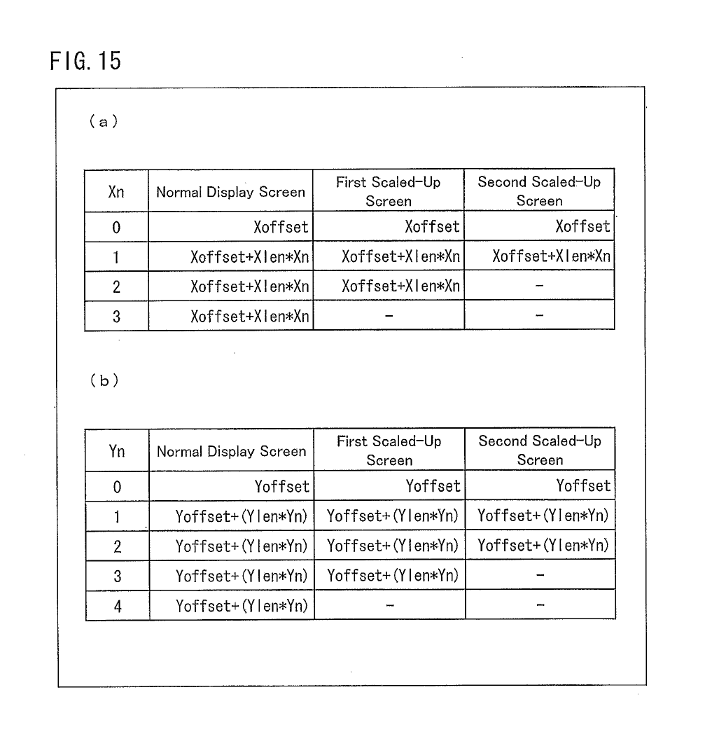

FIG. 15 illustrates lists of locations and sizes of the thumbnail images 12 illustrated in FIG. 14. (a) of FIG. 15 illustrates X coordinates with respect to columns (Xn) in which thumbnail images 12 are displayed on each of the normal display screen 201, the first scaled-up screen 202, and the second scaled-up screen 203. (b) of FIG. 15 illustrates Y coordinates with respect to rows (Yn) in which thumbnail images 12 are displayed on each of the normal display screen 201, the first scaled-up screen 202, and the second scaled-up screen 203. The display information managing section 105 manages the X coordinates and the Y coordinates (as illustrated in FIG. 15) of thumbnail images 12 displayed on each of the screens.

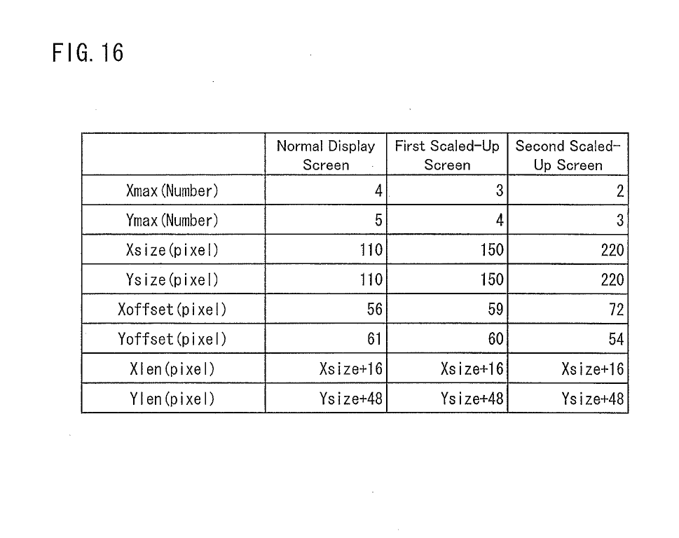

FIG. 16 illustrates examples of Xsize, Ysize, Xoffset, Yoffset, Xlen, and Ylen in accordance with Embodiment 1. According to Embodiment 1, thumbnail images 12 are displayed with the sizes as illustrated in FIG. 16. Note, however, that the locations and the sizes of thumbnail images 12 are not limited to this. Therefore, the locations and the sizes of thumbnail images 12 can be arbitrarily set in accordance with a size of the screen 20 on which the thumbnail images 12 are displayed.

As such, the content display device of Embodiment 1 (i) displays a plurality of thumbnail images 12 on the screen 20 in the first arrangement, which is a predetermined arrangement order of the plurality of thumbnail images 12, and (ii) accepts, from a user, an input of an instruction on scaling up a display size of a specified thumbnail image 12 which is any of the plurality of thumbnail images 12 displayed on the screen 20. Then, when the input has been accepted, the content display device scales up a display size of a predetermined number of thumbnail images 12 which (i) include the specified thumbnail image 12 and (ii) are sequentially arranged on the screen 20 in accordance with the arrangement order. Then, the content display device moves the predetermined number of thumbnail images 12, which have been scaled up, on the screen 20 such that the predetermined number of thumbnail images 12 are displayed on the screen 20 in a second arrangement, which (i) is a predetermined arrangement order of thumbnail images 12 and (ii) is different from the first arrangement.

According to the configuration, in a case where the user carries out an input of an instruction, with respect to a display of a plurality of thumbnail images 12, on changing (i.e., scaling up or scaling down) a display size of a thumbnail image 12 (specified content) which has been specified out of the plurality of thumbnail images 12, the specified thumbnail image 12 is surely displayed on the screen 20 after the display size has been changed. In other words, the specified content will not disappear from the screen after the display size has been changed. Therefore, the user does not need to scroll the screen in order to display the specified content on the screen after the display size has been changed.

Thumbnail images 12, which respectively precedes and follows the specified content before the display size is changed, are to still precede and follow the specified content, respectively, even after the display size is changed. That is, the plurality of thumbnail images 12 will not be displayed in a discrete manner. This allows the user to always feel consistency in the arrangement of the thumbnail images 12, and therefore the user can comfortably operate the content display device.

As such, according to the present invention, it is possible to provide the content display device that has a user interface which can be easily operated by the user.

The thumbnail image 12, which has been specified by the user, is moved so that a display location of the specified thumbnail image 12, whose display size has been scaled up, at least partially overlaps with a display location of the specified thumbnail image 12 whose display size has not been scaled up. This allows the specified thumbnail image 12 to be displayed at locations close to each other before and after the display size is scaled up. Therefore, the user does not need to look for the specified thumbnail image 12, and accordingly user-friendliness is further improved.

In a case where the content display device accepts, from the user, an instruction on scaling up the display size of the plurality of contents, the content display device can display, on the screen, the plurality of contents which have been scaled up and are arranged in a matrix in which number of columns and number of rows are smaller than those before the display size is scaled up.

According to Embodiment 1, after the display size of the predetermined number of thumbnail images 12 is scaled up, the predetermined number of thumbnail images 12, whose display size has been scaled up, are moved. This allows the user to carry out a scaling-up instruction while confirming the display size of the thumbnail images 12 on the screen 20.

(Display Location of Specified Thumbnail Image 12)

In Embodiment 1, the configuration has been described in which the thumbnail image 12 specified by the user is displayed at locations close to each other before and after the display size is scaled up. Note, however, that the location, at which the specified thumbnail image 12 is displayed on the screen 20 after the display size is scaled up, is not limited to this.

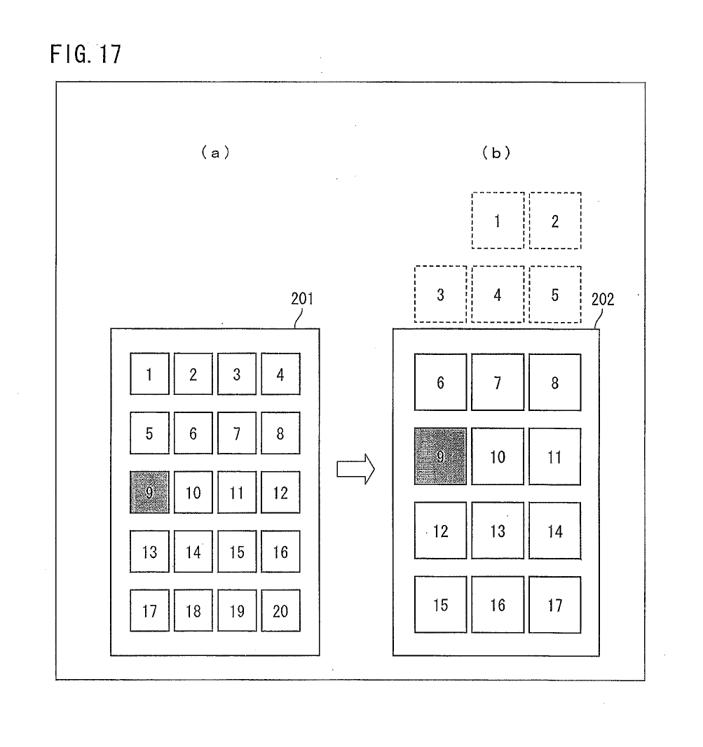

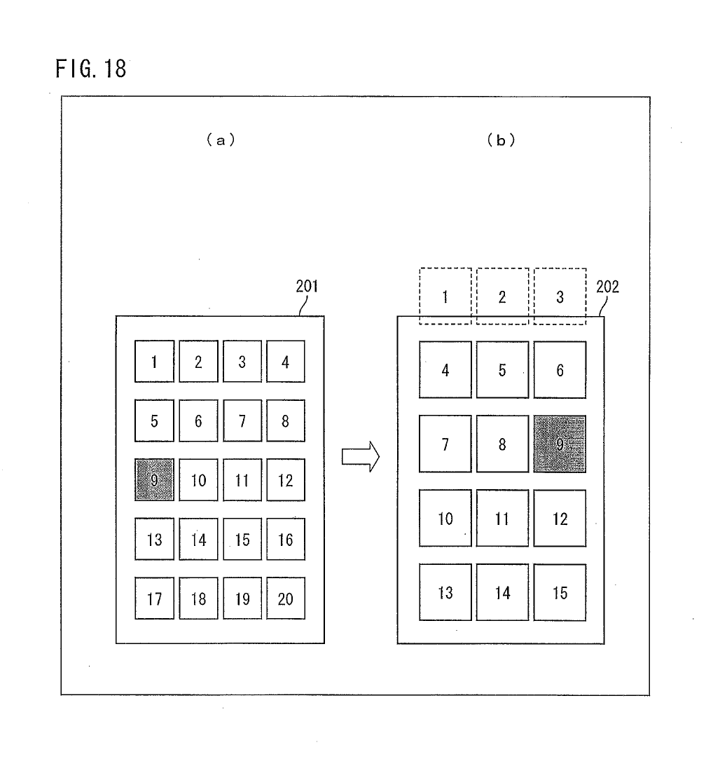

FIG. 17 is a view illustrating a location of a thumbnail (1) in a case where a location, at which the specified thumbnail image 12 is displayed on the screen 20 after the display size is scaled up, is nearest to a location at which the specified thumbnail image 12 is currently displayed on the screen 20. FIG. 18 is a view illustrating the first scaled-up screen 202 and a location of the thumbnail (1), in a case where the location of the thumbnail (1) is set to a leftmost column.

In a case where a thumbnail image 12 (i.e., thumbnail (9)) which has a thumbnail ID of 9 displayed on the normal display screen 201 illustrated in (a) of FIG. 17 is subjected to pinch-out, the display screen changes to the first scaled-up screen 202 as illustrated in (b) of FIG. 17. In this case, the first scaled-up screen 202 displays the thumbnail images 12 which are thumbnails (6) through (17) as illustrated in (b) of FIG. 17. The thumbnail (9) is displayed at a location in the second row of the first column, which is nearest to a location at which the thumbnail (9) has been displayed on the normal display screen 201. In a case where an arrangement of the thumbnails (1) through (8) is changed while being centered on the thumbnail (9), the thumbnails (1) through (5) (i) are to be arranged above the thumbnail (6) as indicated by dotted lines and accordingly (ii) are not displayed on the first scaled-up screen 202.

Here, in a case where the thumbnails are arranged so that the thumbnail (1) is located in a leftmost column, the thumbnail (9) is displayed in the third row of the first (see (b) of FIG. 18). As such, it is possible to employ the configuration in which the thumbnail (1) is located in the leftmost column.

(Regarding Animation)

In the above description discussed with reference to FIGS. 7 through 11, the scaling up and the moving are separately carried out. Note, however, that the scaling up and the moving can be simultaneously carried out as illustrated in FIG. 4.

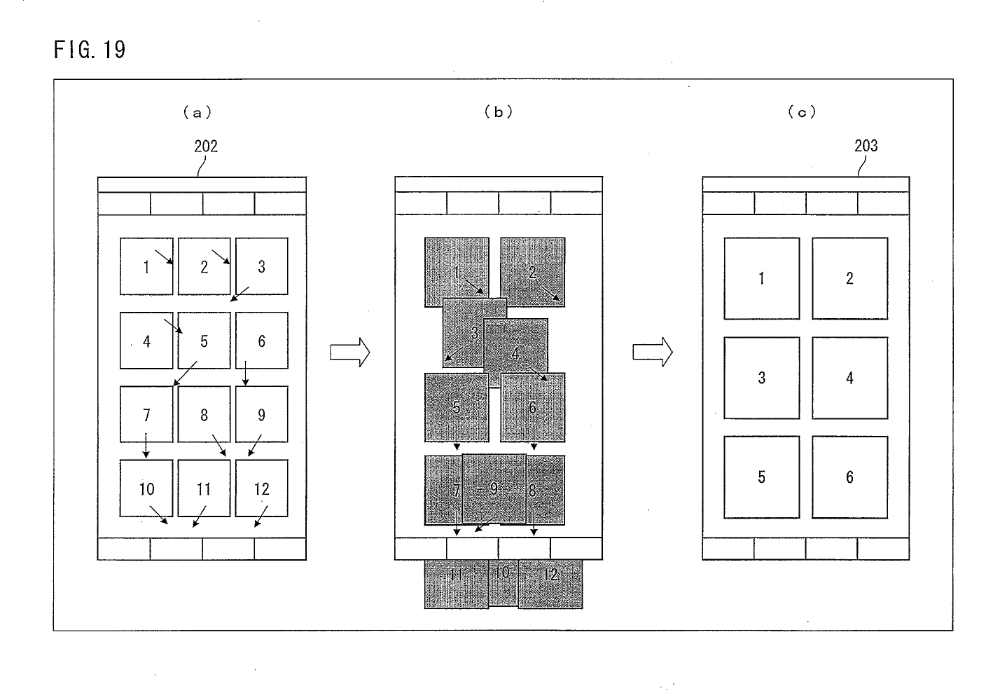

FIG. 19 is a view illustrating a display screen in which a scaling-up animation and a moving animation are simultaneously performed.

As illustrated in (a) of FIG. 19, in a case where a thumbnail image 12 (thumbnail (1)) having a thumbnail ID of 1 is specified and then subjected to pinch-out on the first scaled-up screen 202, an animation screen is displayed in which the thumbnail images 12 are moved while being scaled up (see (b) of FIG. 19). Subsequently, the fitting is carried out and accordingly the display screen is changed to the second scaled-up screen 203 as illustrated in (c) of FIG. 19.

As such, in a case where the scaling up and the moving are simultaneously carried out, the user can confirm the plurality of thumbnail images 12, which have been scaled up and moved, immediately after the user gives an instruction on scaling up the display size.

(Timings of Scaling up, Moving, and Fitting)

According to Embodiment 1, it is preferable that (i) the scaling up and the moving of the thumbnail images 12 are carried out before a finger is released from the screen 20 and (ii) the fitting is carried out when the finger is released from the screen 20. The timings at which the scaling up, the moving, and the fitting of the thumbnail images 12 are not limited to those. For example, the scaling up, the moving, and the fitting of the thumbnail images 12 can be carried out after the finger is released from the screen 20 or before the finger is released from the screen 20. Alternatively, for example, (i) the scaling up of the thumbnail image 12 can be carried out while the finger is making contact with the screen 20 and (ii) the moving and the fitting can be carried out when the finger is released from the screen 20. As such, the scaling up, the moving, and the fitting can be carried out at various timings. By thus carrying out the scaling-up process at such a timing, the user can change the size of the thumbnail images 12 while confirming the size of the thumbnail images 12 displayed on the screen 20.

(Another Example of Scaling-Up Process)

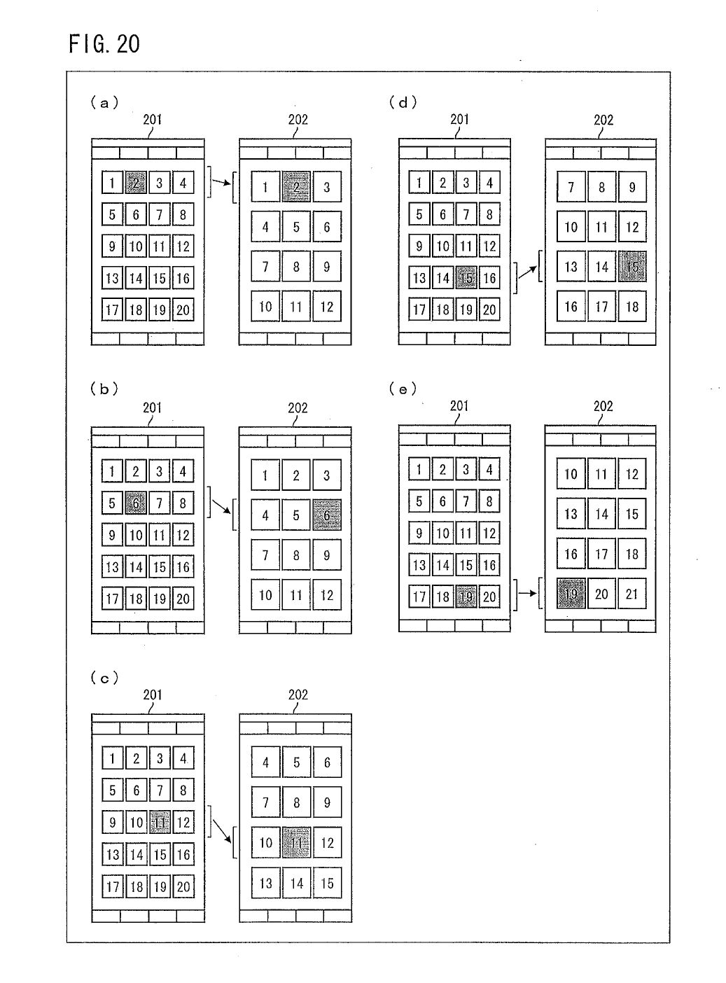

Next, the following description will discuss, with reference to FIGS. 20 through 22, a scaling-up process carried out in a case where a row in which a specified thumbnail image 12 is displayed on the screen 20 after being scaled up is determined in advance.

FIG. 20 is a view for explaining a row in which one (1) thumbnail image 12, which has been specified out of a plurality of thumbnail images 12 displayed on a normal display screen 201 and which has been subjected to pinch-out, is displayed on a first scaled-up screen 202.

In a case where a thumbnail (2) located in the first row on the normal display screen 201 is specified, the thumbnail (2) is displayed in the first row on the first scaled-up screen 202 (see (a) of FIG. 20).

In a case where a thumbnail (6) located in the second row on the normal display screen 201 is specified, the thumbnail (6) is displayed in the second row on the first scaled-up screen 202 (see (b) of FIG. 20).

In a case where a thumbnail (11) located in the third row on the normal display screen 201 is specified, the thumbnail (11) is displayed in the third row on the first scaled-up screen 202 (see (c) of FIG. 20).

In a case where a thumbnail (15) located in the fourth row on the normal display screen 201 is specified, the thumbnail (15) is displayed in the third row on the first scaled-up screen 202 (see (d) of FIG. 20).

In a case where a thumbnail (19) located in the fifth row on the normal display screen 201 is specified, the thumbnail (19) is displayed in the fourth row on the first scaled-up screen 202 (see (e) of FIG. 20).

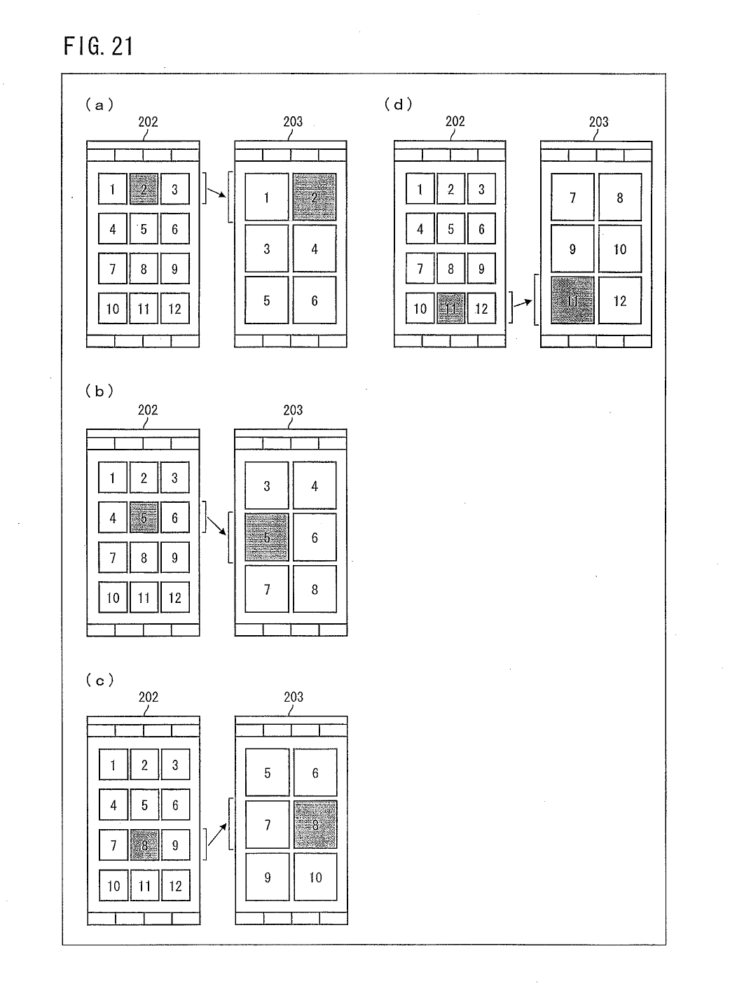

FIG. 21 is a view for explaining a row in which one (1) thumbnail image 12, which has been specified out of a plurality of thumbnail images 12 displayed on the first scaled-up screen 202 and which has been subjected to pinch-out, is displayed on a second scaled-up screen 203.

In a case where a thumbnail (2) located in the first row on the first scaled-up screen 202 is specified, the thumbnail (2) is displayed in the first row on the second scaled-up screen 203 (see (a) of FIG. 21).

In a case where a thumbnail (5) located in the second row on the first scaled-up screen 202 is specified, the thumbnail (5) is displayed in the second row on the second scaled-up screen 203 (see (b) of FIG. 21).

In a case where a thumbnail (8) located in the third row on the first scaled-up screen 202 is specified, the thumbnail (8) is displayed in the second row on the second scaled-up screen 203 (see (c) of FIG. 21).

In a case where a thumbnail (11) located in the fourth row on the first scaled-up screen 202 is specified, the thumbnail (11) is displayed in the third row on the second scaled-up screen 203 (see (d) of FIG. 21).

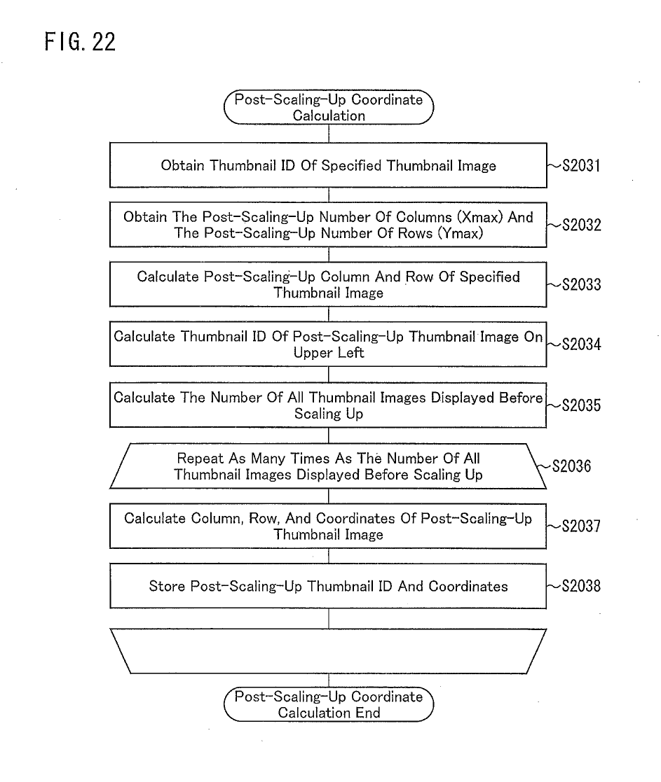

FIG. 22 is a flowchart illustrating an example flow of a post-scaling-up coordinate calculation process carried out in a case where a row in which a specified thumbnail image 12 is displayed on the screen 20 after being scaled up is determined in advance.

Processes at S2031 and S2032 in FIG. 22 are similar to those at S1031 and S1032 in FIG. 9, respectively, and therefore descriptions of S2031 and S2032 are omitted here.

Then, the coordinate calculation processing section 121 obtains in what row (Yn(f)) of what column (Xn(f)) the specified thumbnail image 12 is displayed on the screen 20 (S2033).

Thereafter, the coordinate calculation processing section 121 calculates, based on the following equation (3), a thumbnail ID of a thumbnail image 12 displayed on the upper left of the screen 20 after being scaled up.

IDul=ID−(Yn×Xmax+Xn) (3)

where “IDul” indicates the thumbnail ID of the thumbnail image 12 located on the upper left of the screen 20. The coordinate calculation processing section 121 calculates, by substituting Xn=Xn(f), Yn=Yn(f), and Xmax=X max(f) for the equation (3), the thumbnail ID of the thumbnail image 12 located on the upper left of the screen 20 (S2034).

Thereafter, processes (at S2035 through S2038) similar to those at S1035 through S1038 in FIG. 9, respectively, are carried out.

As described above, display locations of the respective thumbnail images 12 may be determined in advance.

That is, it is possible that coordinates of a display location of each of the thumbnail images 12, which are arranged before the scaling up is carried out, are determined in advance; coordinates of a display location of each of the thumbnail images 12, which are arranged after the scaling up is carried out, are determined in advance; and a destination of each of the thumbnail images included in the predetermined number of thumbnail images 12 is determined based (i) on the coordinates of the display location of the each of the thumbnail images 12 arranged before the scaling up is carried out and (ii) on the coordinates of the display location of the each of the thumbnail images 12 arranged after the scaling up is carried out. This makes it possible to immediately move the predetermined number of thumbnail images 12.

### Embodiment 2

The description of Embodiment 1 has taken, as an example, a case where one of the plurality of thumbnail images 12 displayed on the screen 20 is specified and scaled up. Alternatively, in the present invention, a thumbnail image 12 can also be scaled down. The following description will discuss a scaling-down process.

(Process for Scaling down Thumbnail Image 12)

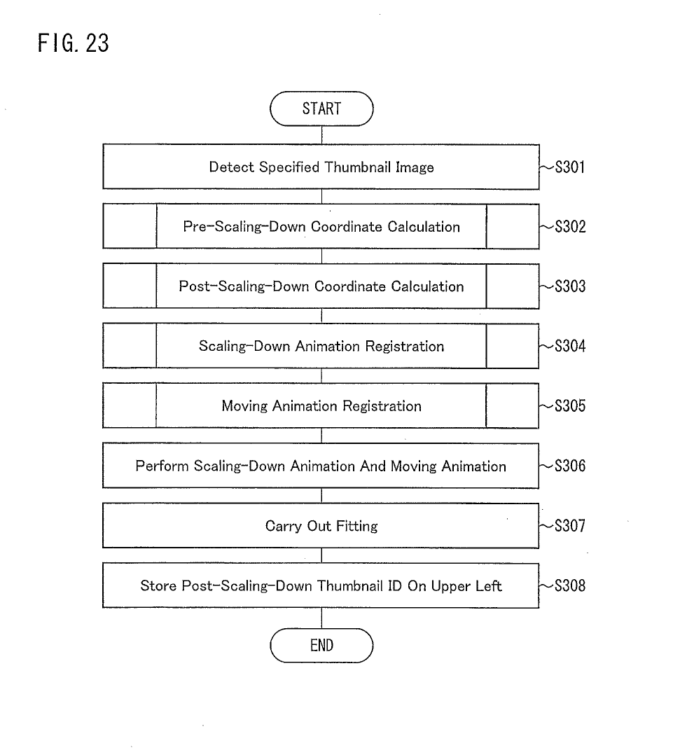

Next, a process for scaling down a thumbnail image 12 is described below with reference to FIG. 23 through FIG. 27. FIG. 23 is a flowchart illustrating a process for scaling down a thumbnail image 12 which has been specified by a user and subjected to pinch-in.

The user specifies, to a display section 112, any one of the plurality of thumbnail images 12 displayed on the screen 20, and an input operation section 111 detects that pinch-in has been performed on the specified thumbnail image 12. An input processing section 101 receives information on such an input operation (S301).

Thereafter, a coordinate calculation processing section 121 calculates pre-scaling-down coordinates of the specified thumbnail image 12 and the others of the plurality of the thumbnail images 12 displayed on the screen 20 (S302, a pre-scaling-down coordinate calculation process). Further, the coordinate calculation processing section 121 calculates post-scaling-down coordinates of the specified thumbnail image 12 and the others of the plurality of the thumbnail images 12 displayed on the screen 20 (S303, a post-scaling-down coordinate calculation process).

Next, a scaling up/down display processing section 123 registers a post-scaling-down thumbnail size of the thumbnail image 12, and carries out a preprocess for generating an image and a scaling-down animation which are used when the display section 112 displays a scaled down book list (S304, a scaling-down animation registration process). Then, a moving display processing section 124 registers post-moving coordinates of the thumbnail image 12, and carries out a preprocess for generating an image and a moving animation which are used when the display section 112 displays a book list, the moving animation moving to post-scaling-down coordinates (S305, a moving animation registration process).

Subsequently, the scaling up/down display processing section 123 generates an image and a scaling-down animation which are used when the display section 112 displays a scaled down book list. Then, the scaling up/down display processing section 123 sends, to an output processing section 110, the image and the scaling-down animation which have been generated. The output processing section 110 receives display contents sent from the scaling up/down display processing section 123, and causes the scaling-down animation and the image to be displayed (a changing step, a changing process). The moving display processing section 124 generates an image and a scaling-down animation which are used when the display section 112 displays a book list. Then, the moving display processing section 124 sends, to the output processing section 110, the image and the moving animation which have been generated. The output processing section 110 receives display contents sent from the moving display processing section 124, and causes the moving animation and the image to be displayed (a moving step, a moving process) (S306).

Thereafter, a fitting display processing section 125 generates an image in which the plurality of thumbnail images 12 displayed on the screen 20 have been moved so that Y coordinates of the respective plurality of thumbnail images 12 displayed on the screen 20 match Y coordinates calculated at S303. Then, the fitting display processing section 125 sends the image to the output processing section 110. The output processing section 110 receives display contents sent from the fitting display processing section 125, and causes the image to be displayed (S307).

A coordinate managing section 122 causes a storage device to store a thumbnail ID of a thumbnail image 12 displayed on the upper left of the screen 20 in which the display size has been scaled down (S308).

(Pre-Scaling-Down Coordinate Calculation Process)

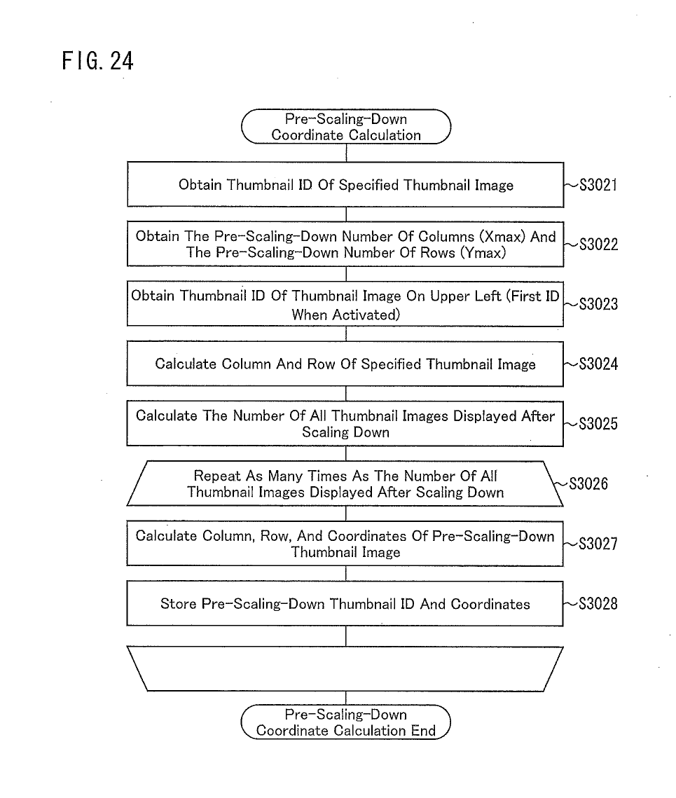

Next, a process at 5302 for calculating pre-scaling-down coordinates of a thumbnail image 12 is described below with reference to FIG. 24. FIG. 24 is a flowchart illustrating an example flow of the pre-scaling-down coordinate calculation process in FIG. 23.

The coordinate calculation processing section 121 obtains, from the input processing section 101, a thumbnail ID of the specified thumbnail image 12 (S3021). Next, the coordinate calculation processing section 121 obtains the number of columns (Xmax) and the number of rows (Ymax) of thumbnail images 12 displayed on the screen 20 in this case (S3022). Note here that the pre-scaling-down number of columns is indicated by “Xmax(p)” and the pre-scaling-down number of rows is indicated by “Ymax(p)”.

Subsequently, the coordinate calculation processing section 121 obtains a thumbnail ID of a thumbnail image 12 displayed on the upper left of the screen 20 in this case. Note here that the thumbnail ID of the thumbnail image 12 located on the upper left of the screen 20 is the thumbnail ID stored in advance in the storage device at 5308. Note that the thumbnail image 12 located on the upper left of the screen 20 has the first ID (e.g., a thumbnail ID of 1) when a content display device 1 is activated (S3023).

Then, the coordinate calculation processing section 121 calculates in what row (Yn(p)) of what column (Xn(p)) the specified thumbnail image 12 is displayed on the screen 20, based on the following equations (4) and (5):

Xn=(ID−1)mod(Xmax) (4)

Yn=(ID−StartID)/(Xmax) (5)

where “ID” indicates the thumbnail ID of the specified thumbnail image 12, “StartID” indicates the thumbnail ID, obtained at S3023, of the thumbnail image 12 displayed on the upper left of the screen 20.

The coordinate calculation processing section 121 calculates, by substituting Xn=Xn(p), Yn=Yn(p), and Xmax=Xmax(p) for the equations (4) and (5), a column and a row in which the specified thumbnail image 12 is displayed on the screen 20 (S3024).

Next, the coordinate calculation processing section 121 calculates the number of all the thumbnail images to be displayed after the thumbnail images are scaled down (S3025).

Subsequently, the coordinate calculation processing section 121 calculates (i) a thumbnail ID of each of the plurality of thumbnail images 12 displayed on the screen 20, (ii) a column (Xn) and a row (Yn) in which the each of the plurality of thumbnail images 12 is displayed on the screen 20, and (iii) coordinates (X, Y) of the each of the plurality of thumbnail images 12 on the screen 20 on which the plurality of thumbnail images 12 are displayed (S3027). Note that coordinates of a thumbnail image 12 on the screen 20 are coordinates of an upper left point of the thumbnail image 12. The coordinate managing section 122 causes the calculated coordinates to be stored in the storage device so that the calculated coordinates are associated with the thumbnail ID (S3028). S3027 and S3028 are carried out as many times as the number of the thumbnail images 12 which number has been calculated at S3025 (S3026).

(Post-Scaling-Down Coordinate Calculation Process)

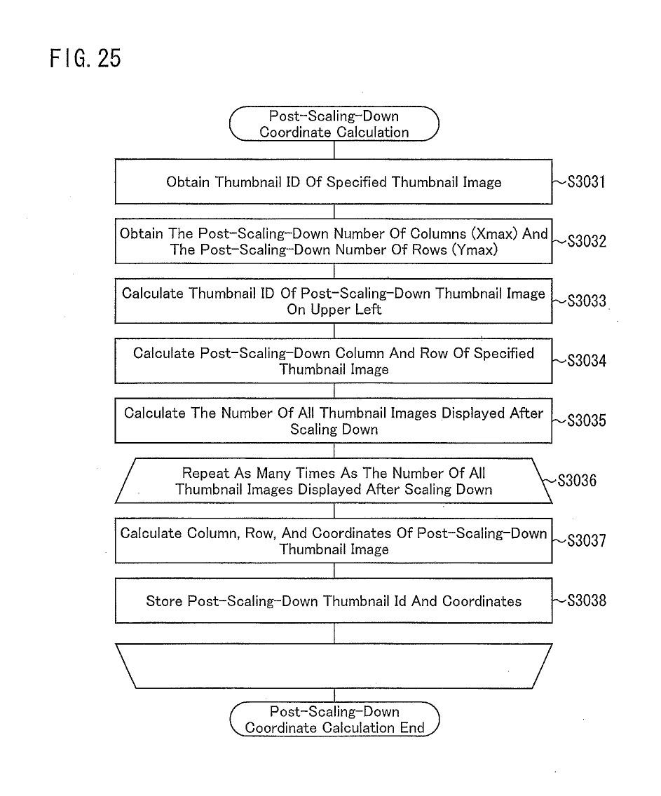

Next, a process at 5303 for calculating post-scaling-down coordinates of a thumbnail image 12 is described below with reference to FIG. 25. FIG. 25 is a flowchart illustrating an example flow of the post-scaling-down coordinate calculation process in FIG. 23.

The coordinate calculation processing section 121 obtains, from the input processing section 101, a thumbnail ID of the specified thumbnail image 12 (S3031). Next, the coordinate calculation processing section 121 obtains the number of columns (Xmax) and the number of rows (Ymax) of thumbnail images 12 displayed on the screen 20 in this case (S3032). Note here that the post-scaling-up number of columns is indicated by “Xmax(f)” and the post-scaling-up number of rows is indicated by “Ymax(f)”.

Subsequently, the coordinate calculation processing section 121 obtains a thumbnail ID of a thumbnail image 12, located on the upper left of the screen 20, of a plurality of thumbnail images 12 displayed on the screen 20 after the scaling up. Note here that the thumbnail ID of the thumbnail image 12 located on the upper left of the screen 20 is the thumbnail ID stored in advance in the storage device at S308 (S3033).

Then, the coordinate calculation processing section 121 calculates in what row (Yn(f)) of what column (Xn(f)) the specified thumbnail image 12 is displayed on the screen 20, based on the equations (4) and (5): where “StartID” indicates the thumbnail ID, obtained at S3033, of the thumbnail image 12 displayed on the upper left of the screen 20. The coordinate calculation processing section 121 calculates, by substituting Xn=Xn(f), Yn=Yn(f), and Xmax=X max(f) for the equations (4) and (5), a column and a row in which the specified thumbnail image 12 is displayed on the screen 20 (S3034).

Next, the coordinate calculation processing section 121 calculates the number of all the thumbnail images to be displayed after the thumbnail images are scaled down (S3035).

Subsequently, the coordinate calculation processing section 121 calculates (i) a thumbnail ID of each of the plurality of thumbnail images 12 displayed on the screen 20 after the plurality of thumbnail images 12 have been scaled down, (ii) a column (Xn) and a row (Yn) in which the each of the plurality of thumbnail images 12 is displayed on the screen 20, and (iii) coordinates (X, Y) of the each of the plurality of thumbnail images 12 on the screen 20 on which the plurality of thumbnail images 12 are displayed (S3037). The coordinate managing section 122 causes the calculated coordinates to be stored in the storage device so that the calculated coordinates are associated with the thumbnail ID (S3038). S3037 and S3038 are carried out as many times as the number of the thumbnail images 12 which number has been calculated at S3035 (S3036).

(Scaling-Down Animation Registration Process)

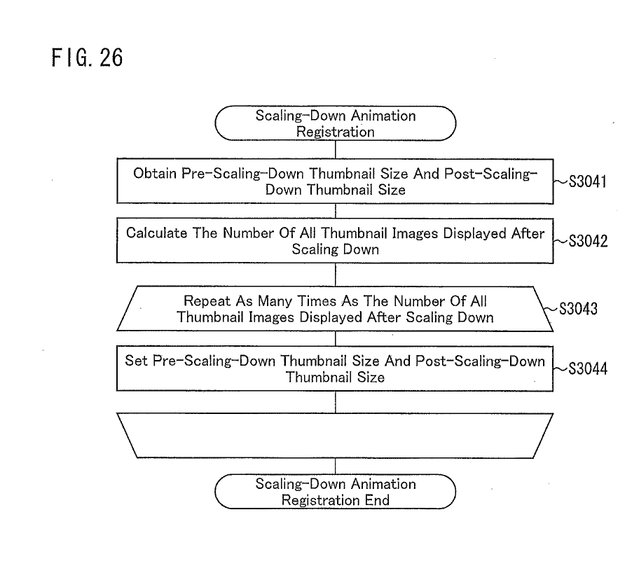

Next, a scaling-down animation registration process at S304 is described below with reference to FIG. 26. FIG. 26 is a flowchart illustrating an example flow of the scaling-down animation registration process in FIG. 23.

The scaling up/down display processing section 123 obtains, from a display information managing section 105, a pre-scaling-down thumbnail size and a post-scaling-down thumbnail size of the specified thumbnail image 12 (S3041). Subsequently, the scaling up/down display processing section 123 calculates the number of all the thumbnail images 12 to be displayed on the screen 20 after the thumbnail images 12 are scaled down (S3042).

Thereafter, the scaling up/down display processing section 123 sets a pre-scaling-up thumbnail size and a post-scaling-up thumbnail size for each of the thumbnail images 12 (S3044). S3044 is carried out as many times as the number of the thumbnail images 12 which number has been calculated at S3042 (S3043).

(Moving Animation Registration Process)

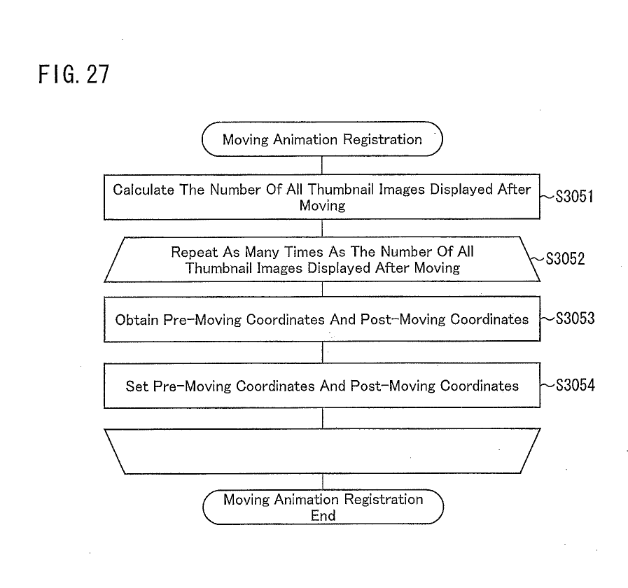

Next, a moving animation registration process at 5305 is described below with reference to FIG. 27. FIG. 27 is a flowchart illustrating an example flow of the moving animation registration process in FIG. 23.

The moving display processing section 124 calculates the number of all the thumbnail images 12 to be displayed on the screen 20 after the thumbnail images have moved (S3051). Thereafter, the moving display processing section 124 obtains, from the coordinate managing section 122, pre-moving coordinates and post-moving coordinates of a thumbnail image 12 (S3053), and sets the pre-moving coordinates and the post-moving coordinates for each of the thumbnail images 12 (S3054). S3053 and S3054 are carried out as many times as the number of the thumbnail images 12 which number has been calculated at S1051 (S3052).

As described above, in response to an instruction from the user on scaling down a display size of the plurality of thumbnail images 12, the content display device can display, on the screen 20, the plurality of thumbnail images 12 which have been scaled down and are arranged in a matrix larger than that in which the plurality of thumbnail images 12 are arranged before being scaled down.

As described above, also for the scaling down, as in the case of the scaling up, before and after being scaled down, the thumbnail image 12 specified by the user can be displayed at locations close to each other.

(Display Location of Specified Thumbnail Image 12)

According to Embodiment 2, as to a location at which the specified thumbnail image 12 is displayed on the screen 20 after the display size has been scaled down, as in the case of the scaling-up process, it is preferable that before and after being scaled down, the thumbnail image 12 specified by the user be displayed on the screen 20 at locations close to each other. Note that the location at which the specified thumbnail image 12 is displayed on the screen 20 after being scaled down is not limited to this. Also in the scaling-down process, as in the case of the scaling-up process, the specified thumbnail image 12 may be displayed at a location at which a thumbnail (1) is arranged so as to be located at the left end of the screen 20.

(Another Example of Scaling-Down Process)

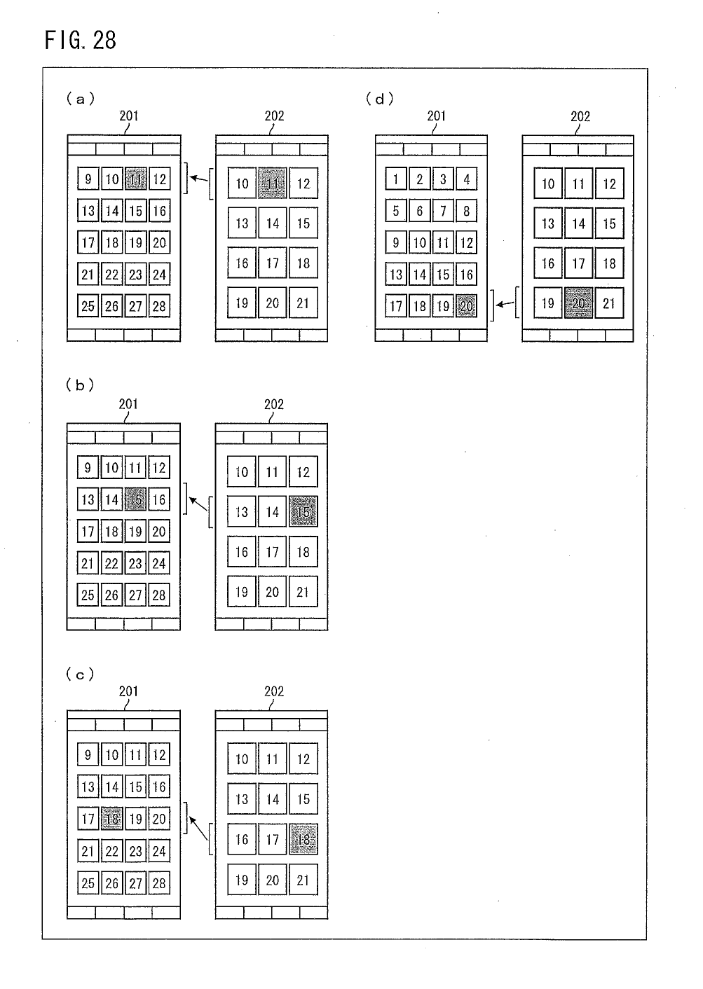

Next, the following description will discuss, with reference to FIG. 28 through FIG. 30, a scaling-down process carried out in a case where a row in which a specified thumbnail image 12 is displayed on the screen 20 after being scaled down is determined in advance.

FIG. 28 is a view for explaining a row in which one (1) thumbnail image 12, which has been specified out of a plurality of thumbnail images 12 displayed on a first scaled-up screen 202 and which has been subjected to pinch-in, is displayed on a normal display screen 201.

In a case where a thumbnail (11) located in the first row on the first scaled-up screen 202 is specified, the thumbnail (11) is displayed in the first row on the normal display screen 201 (see (a) of FIG. 28).

In a case where a thumbnail (15) located in the second row on the first scaled-up screen 202 is specified, the thumbnail (15) is displayed in the second row on the normal display screen 201 (see (b) of FIG. 28).

In a case where a thumbnail (18) located in the third row on the first scaled-up screen 202 is specified, the thumbnail (18) is displayed in the third row on the normal display screen 201 (see (c) of FIG. 28).

In a case where a thumbnail (20) located in the fourth row on the first scaled-up screen 202 is specified, the thumbnail (20) is displayed in the fifth row on the normal display screen 201 (see (d) of FIG. 28).

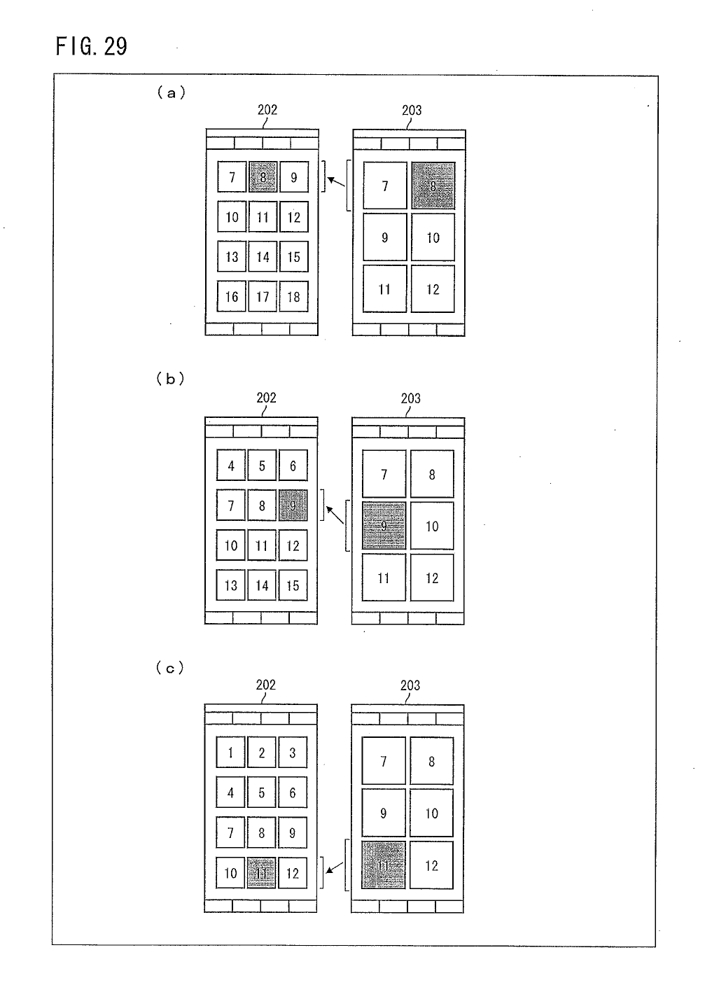

FIG. 29 is a view for explaining a row in which one (1) thumbnail image 12, which has been specified out of a plurality of thumbnail images 12 displayed on a second scaled-up screen 203 and which has been subjected to pinch-in, is displayed on the first scaled-up screen 202.

In a case where a thumbnail (8) located in the first row on the second scaled-up screen 203 is specified, the thumbnail (8) is displayed in the first row on the first scaled-up screen 202 (see (a) of FIG. 29).

In a case where a thumbnail (9) located in the second row on the second scaled-up screen 203 is specified, the thumbnail (9) is displayed in the second row on the first scaled-up screen 202 (see (b) of FIG. 29).

In a case where a thumbnail (11) located in the third row on the second scaled-up screen 203 is specified, the thumbnail (11) is displayed in the fourth row on the first scaled-up screen 202 (see (c) of FIG. 29).

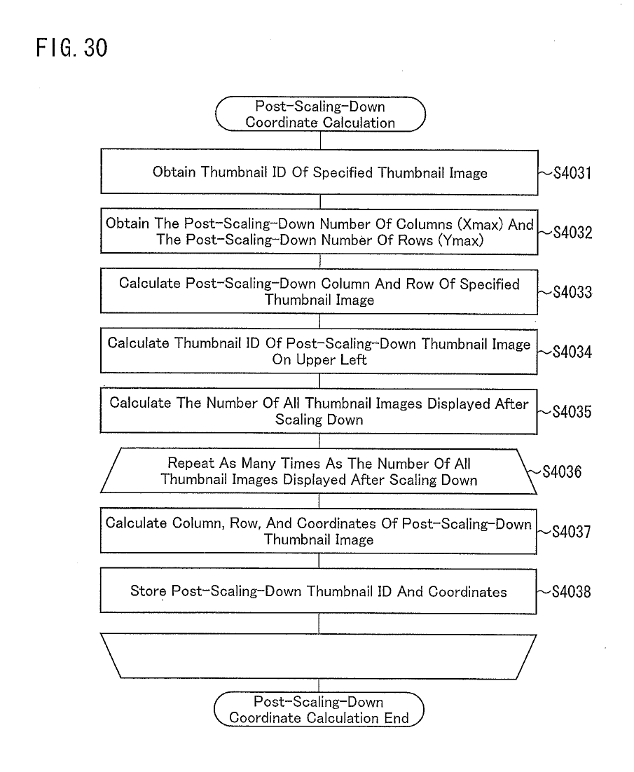

FIG. 30 is a flowchart illustrating an example flow of a post-scaling-down coordinate calculation process carried out in a case where a row in which a specified thumbnail image 12 is displayed on the screen 20 after being scaled down is determined in advance.

Processes at S4031 and S4032 in FIG. 30 are similar to those at S3031 and S3032 in FIG. 25, respectively, and therefore descriptions of S4031 and S4032 are omitted here.

Then, the coordinate calculation processing section 121 obtains in what row (Yn(f)) of what column (Xn(f)) the specified thumbnail image 12 is displayed on the screen 20 (S4033). Thereafter, the coordinate calculation processing section 121 calculates, based on the following equation (6), a thumbnail ID of a thumbnail image 12 displayed on the upper left of the screen 20 after being scaled down.

IDul=ID−(Yn×Xmax+Xn) (6)

where “IDul” indicates the thumbnail ID of the thumbnail image 12 located on the upper left of the screen 20. The coordinate calculation processing section 121 calculates, by substituting Xn=Xn(f), Yn=Yn(f), and Xmax=Xmax(f) for the equation (6), the thumbnail ID of the thumbnail image 12 located on the upper left of the screen 20 (S4034).

Thereafter, processes (at S4035 through S4038) similar to those at S3035 through S3038 in FIG. 25, respectively, are carried out.

As described above, as in the case of the scaling-up process, display locations of the respective thumbnail images 12 may be determined in advance.

(Alignment)

Note that, in a case where a row in which a specified thumbnail image 12 is displayed in the screen 20 after being scaled down is thus determined in advance, rows in each of which no thumbnail image 12 is displayed may be produced in an upper part and a lower part of the screen 20. The fitting display processing section 125 may carry out an alignment of thumbnail images 12 displayed on the screen.

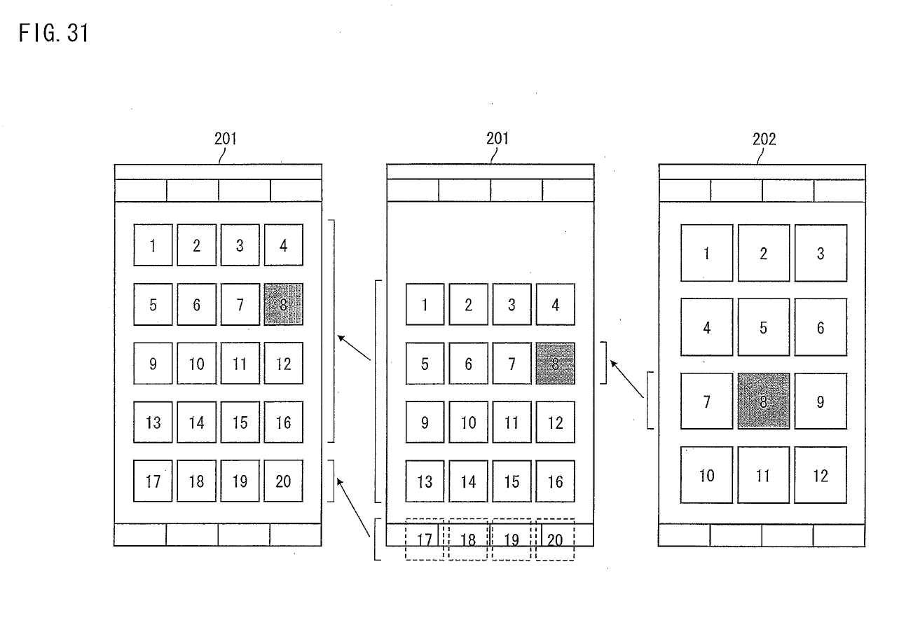

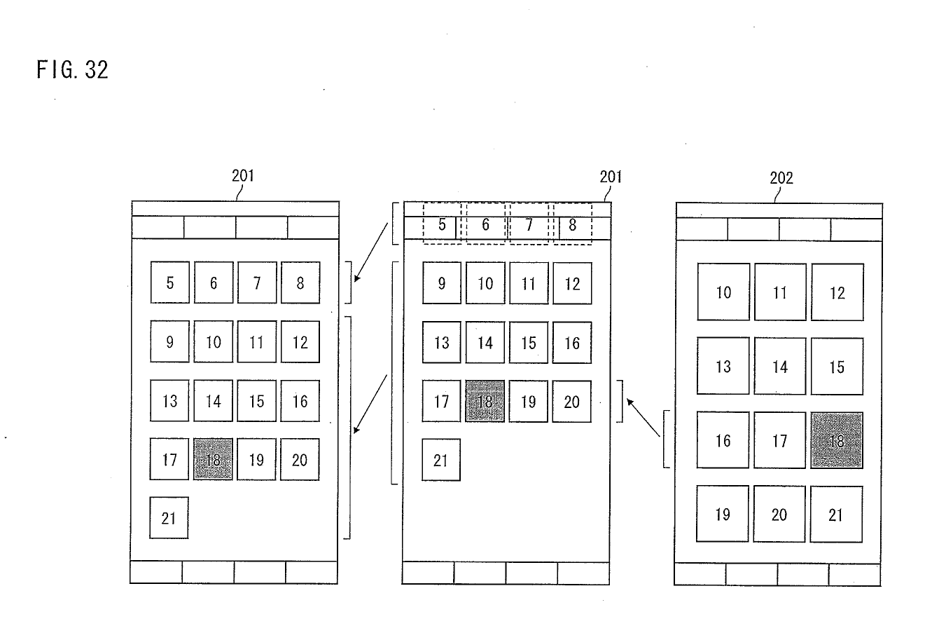

FIG. 31 is a view illustrating (i) the screen 20 that has, in an upper part thereof, a row in which no thumbnail image 12 is displayed, and (ii) the screen 20 in which an alignment of thumbnail images 12 displayed on the screen 20 has been carried out. FIG. 32 is a view illustrating (i) the screen 20 that has, in a lower part thereof, a row in which no thumbnail image 12 is displayed, and (ii) the screen 20 in which an alignment of thumbnail images 12 displayed on the screen 20 has been carried out.

On the first scaled-up screen 202, a thumbnail (8) is specified and subjected to pinch-in (see FIG. 31). The thumbnail (8), which is displayed in the third row on the first scaled-up screen 202, is displayed in the third row on the normal display screen 201 (as early described with reference to (c) of FIG. 28). In this case, if the alignment of the thumbnail images 12 is carried out so that a thumbnail (1) is located at the left end of the normal display screen 201, the thumbnail (8) is displayed at the right end in the third row on the normal display screen 201 (see the drawing at the center of FIG. 31). In this case, the first row on the normal display screen 201 is a blank row in which no thumbnail image 12 is displayed. Therefore, the fitting display processing section 125 shifts thumbnails (1) through (16) upward by one row, so that the thumbnails (1) through (16) are displayed on the normal display screen 201. Further, the fitting display processing section 125 causes thumbnails (17) through (20), which are aligned in order after the thumbnail (16), to be displayed in the fifth row on the normal display screen 201.

Meanwhile, on the first scaled-up screen 202, a thumbnail (18) is specified and subjected to pinch-in (see FIG. 32). The thumbnail (18), which is displayed in the third row on the first scaled-up screen 202, is displayed in the third row on the normal display screen 201 (as early described with reference to (c) of FIG. 28). In this case, if the alignment of the thumbnail images 12 is carried out so that a thumbnail (1) is located at the left end of the normal display screen 201, the thumbnail (18) is displayed in the second column of the third row on the normal display screen 201 (see the drawing at the center of FIG. 32). In this case, the fifth row on the normal display screen 201 is a blank row in which no thumbnail image 12 is displayed. Therefore, the fitting display processing section 125 shifts thumbnails (9) through (21), which are currently being displayed, downward by one row, so that the thumbnails (9) through (21) are displayed on the normal display screen 201. Further, the fitting display processing section 125 causes thumbnails (5) through (8), which are aligned in order after the thumbnail (9), to be displayed in the first row on the normal display screen 201.

### Embodiment 3

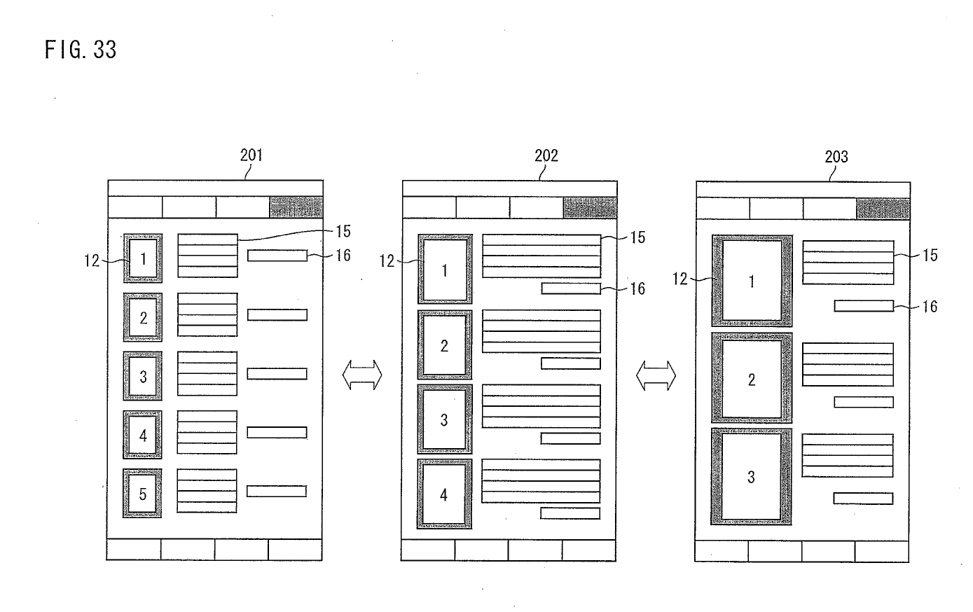

Embodiments 1 and 2 each have discussed a change in size of a thumbnail image 12 on the screen 20 on which the plurality of thumbnail images 12 are list-displayed. However, a method of the present invention for changing a size of a thumbnail image 12 is applied not only to the screen 20 on which the plurality of thumbnail images 12 are list-displayed. The following description will discuss, with reference to FIG. 33 through FIG. 35, a method for displaying a shelf surface 11 whose category is “subscription”.

FIG. 33 is a view illustrating a display state of a screen 20 displaying, in a normal mode, the shelf surface 11 whose category is “subscription”. The shelf surface 11 of subscription is a shelf surface which manages (i) periodicals such as a weekly magazine and a monthly magazine and (ii) back numbers thereof. In order that books distributed by subscription distribution are read, the shelf surface 11, which is a subscription shelf, automatically classifies the distributed books into magazine racks for each of subscription magazines to be distributed. According to the shelf surface 11 of subscription, unlike the case illustrated in FIG. 1, thumbnail images 12 are arranged in a column in a vertical direction on the left side of the shelf surface 11 (see FIG. 33). The thumbnail images 12 are thumbnail images of the latest issues of respective subscription books, and are images such that the latest issues of the respective books are placed on the respective magazine racks. Namely, a state of the shelf surface 11 is similar to a state in which magazine racks for books are arranged in a vertical direction in an actual bookshelf. Next to a thumbnail image 12, book information 15 on a subscription book such as a series title, a title, a publisher, the number of the latest issues, and a commentary is displayed as a text. Next to the book information 15, a selection button 16 is provided for displaying a back number of a corresponding magazine. A back number of a magazine can be displayed not only by selectively operating the selection button 16 but also by carrying out a flick operation or a drag operation with respect to the screen 20 in an upward direction from an image of a magazine rack in which a book (a front cover of a thumbnail image 12) is placed. Note here that the flick operation is realized by a movement of user's fingers which are brought into contact with a touch panel and then quickly flipped in any direction while being in contact with the touch panel. Note also that the drag operation is realized by a movement of user's fingers which are moved in any direction while being in contact with a touch panel.

According to a normal display screen 201 illustrated in the drawing on the right in FIG. 33, in a case where a thumbnail (1) is specified and subjected to pinch-out, not only the thumbnail (1) but also the book information 15 on a book indicated by the thumbnail (1) and the selection button 16 are scaled up on each of a first scaled-up screen 202 and a second scaled-up screen 203. Further, locations of the book information 15 and the selection button 16 are changed so that the book information 15 and the selection button 16 are displayed in each of the first scaled-up screen 202 and the second scaled-up screen 203.

Also in a case where a thumbnail image 12 is scaled down and subjected to pinch-in, not only the thumbnail image 12 but also the information 15 on a book indicated by the thumbnail image 12 and the selection button 16 are scaled down. Further, locations of the book information 15 and the selection button 16 are changed.

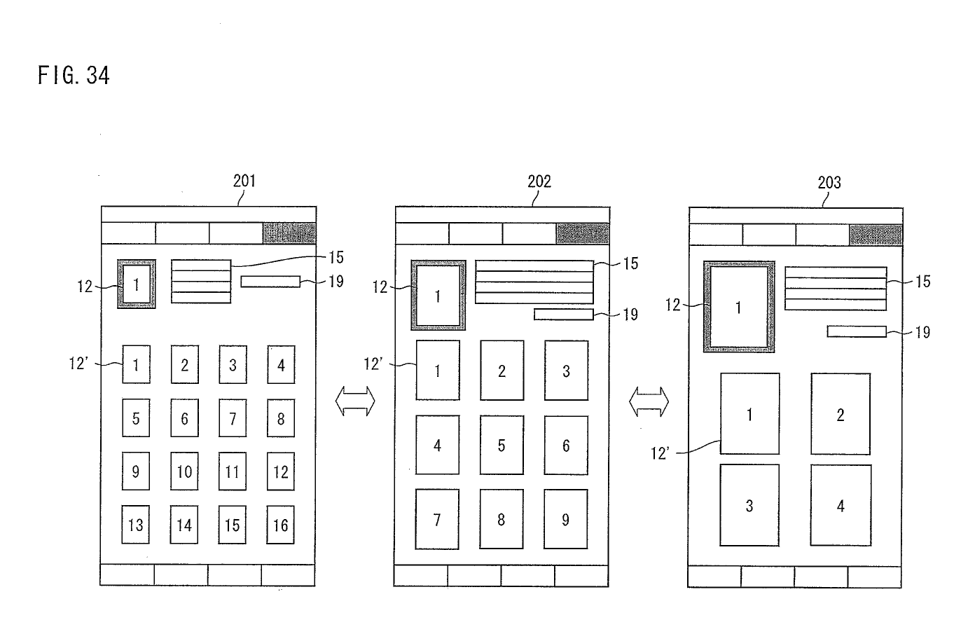

FIG. 34 is a view illustrating the screen 20 in a state in which back numbers of a subscription magazine are list-displayed by tapping a button or flicking a magazine rack on the screen illustrated in FIG. 33. In a case where an input operation for displaying the back numbers is carried out, the state changes to a state in which magazine racks other than a selected magazine rack are not displayed, and a display of the selected magazine rack moves to an upper part of the screen 20 and thumbnail images 12′ of respective back numbers of the subscription magazine are aligned in a grid pattern in a lower part of the screen 20 so as to be list-displayed. According to the present configuration of the screen, the selected magazine rack and a thumbnail image 12 of a front page of the latest issue are displayed in the uppermost stage of the screen 20. Next to the selected magazine rack and the thumbnail image 12, the book information 15 is displayed. Next to the book information 15, a close button 19 instead of the selection button 16 for displaying a back number is displayed. The close button 19 is a button for returning a list display of back numbers to a list display of the latest issues of respective subscription books. Note that it is possible to return to the list display of the latest issues by the flick operation or the drag operation with respect to a magazine rack.

According to the normal display screen 201 illustrated in the drawing on the right in FIG. 34, in a case where a thumbnail image 12 is subjected to pinch-out, not only the thumbnail image 12 but also the book information 15 on a book indicated by the thumbnail image 12 and the close button 19 are scaled up on each of the first scaled-up screen 202 and the second scaled-up screen 203. Further, locations of the book information 15 and the close button 19 are changed so that the book information 15 and the close button 19 are displayed in each of the first scaled-up screen 202 and the second scaled-up screen 203. In addition, the thumbnail images 12′ of the respective back numbers which images are list-displayed are also scaled up, and locations of the thumbnail images 12′ are changed.

Also in a case where a thumbnail image 12 is scaled down and subjected to pinch-in, not only the thumbnail image 12 but also the information 15 on a book indicated by the thumbnail image 12 and the close button 19 are scaled down. Further, locations of the book information 15 and the close button 19 are changed. In addition, the thumbnail images 12′ of the respective back numbers which images are list-displayed are also scaled down, and locations of the thumbnail images 12′ are changed.

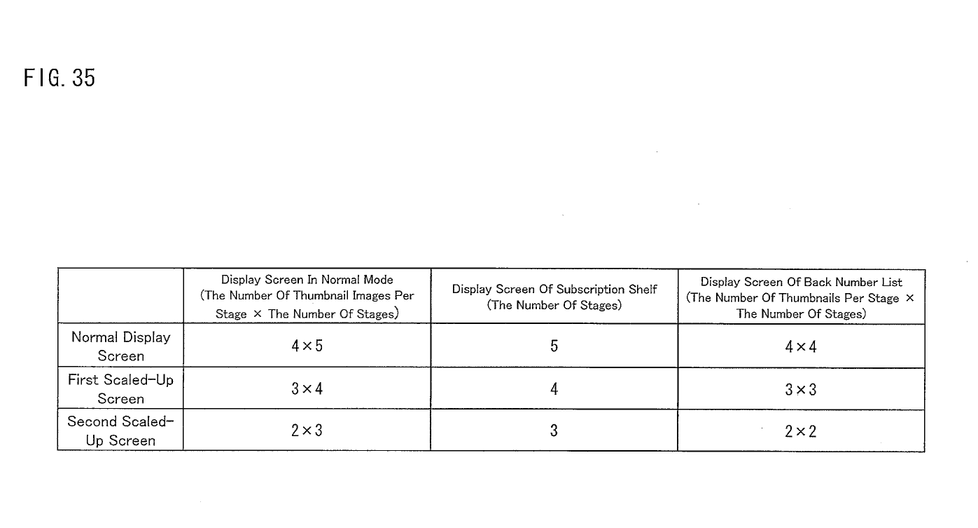

FIG. 35 is a view illustrating the number of books displayed on each screen. In the case of the screens in each of which the thumbnail images are list-displayed (see FIG. 1), the numbers obtained by multiplying the number of thumbnail images 12 displayed in a column (the number of thumbnail images in a stage) by the number of rows (stages) are 4×5 on the normal display screen 201, 3×4 on the first scaled-up screen 202, and 2×3 on the second scaled-up screen 203 (see FIG. 35).

In the case of the screens in each of which the subscription shelf is displayed (see FIG. 35), the thumbnail images 12 are arranged in a column in a vertical direction on the left side of the shelf surface 11. Therefore, the numbers of the thumbnail images 12 (stages) are 5 on the normal display screen 201, 4 on the first scaled-up screen 202, and 3 on the second scaled-up screen 203.

In the case of the screens in each of which the back numbers are list-displayed (see FIG. 34), the numbers obtained by multiplying the number of thumbnail images 12′ displayed in a column (the number of thumbnail images in a stage) by the number of rows (stages) are 4×4 on the normal display screen 201, 3×3 on the first scaled-up screen 202, and 2×2 on the second scaled-up screen 203.

According to scaling means of the present invention, in a case where a size of either of the shelf surfaces 11 illustrated in FIG. 1 is changed, a size of the thumbnail images 12 only on the shelf surface 11 whose size has been changed may be changed, or a size of the thumbnail images 12 on all the shelf surfaces 11 may be changed.

### Embodiment 4

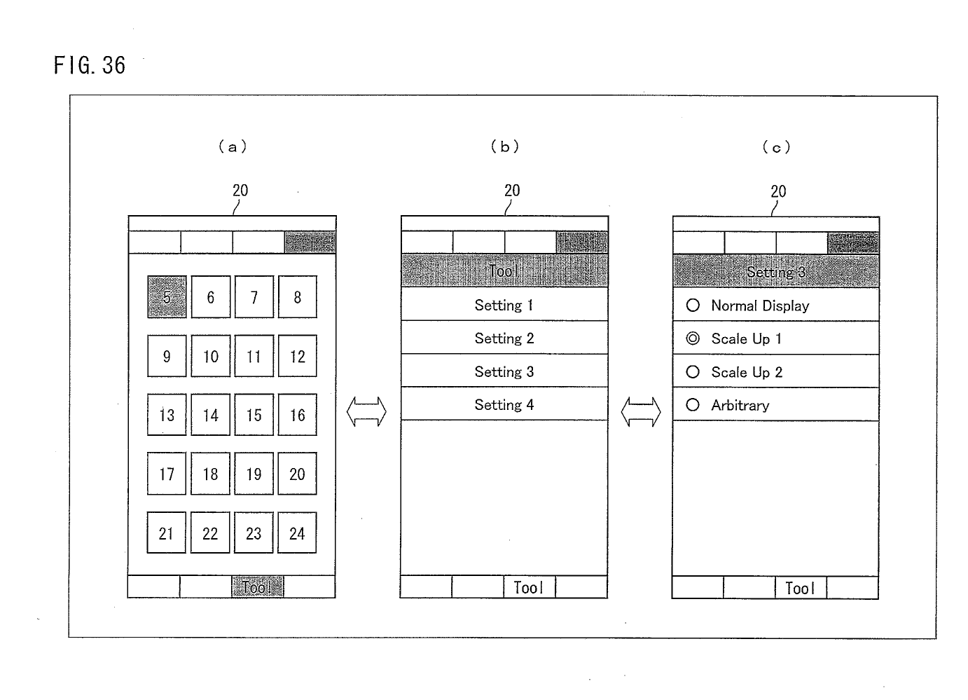

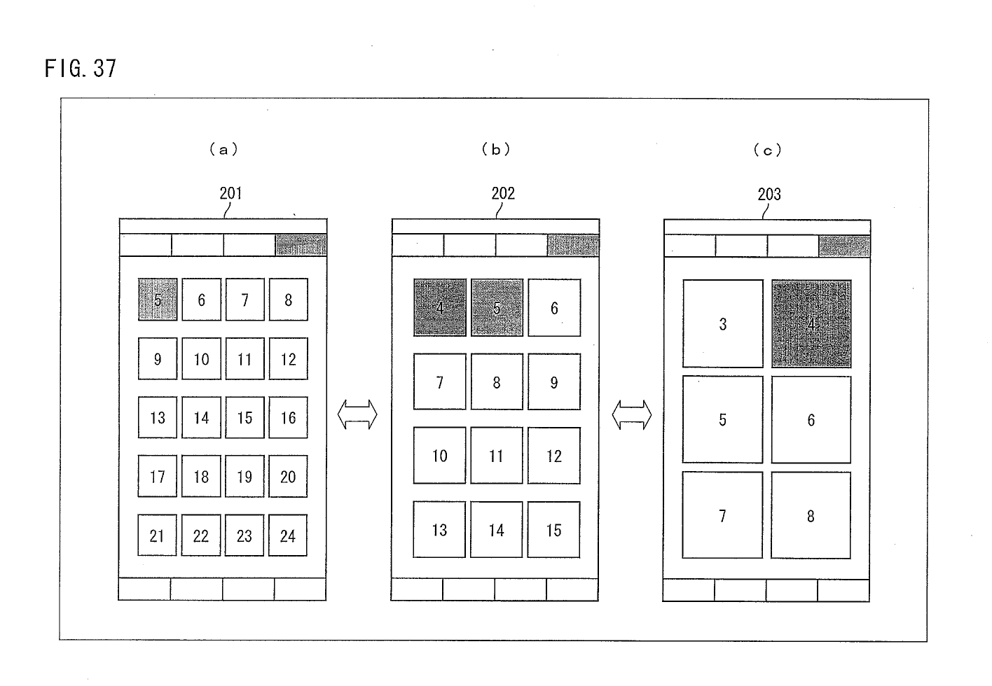

In Embodiments 1 through 3, the configurations have been described in which the user carries out pinch-out or pinch-in with respect to the screen 20 so as to carry out scaling up or scaling down. Note, however, that the scaling up or scaling down of the plurality of thumbnail images 12 displayed on the screen 20 is not limited to this. In Embodiment 4, a process will be described with reference to FIGS. 36 and 37 in which settings for scaling up and scaling down are carried out in advance so that a content, which has been set, is displayed in response to an instruction given by a user.

(Settings for Scaling Up and Scaling Down)

(a) of FIG. 36 illustrates an example of a display screen in accordance with Embodiment 4. (b) of FIG. 36 and (c) of FIG. 36 illustrate an example of the screen 20 on which scaling-up settings are displayed. In a case where a “Tool” button, which is displayed in a lower part of the screen 20 illustrated in (a) of FIG. 36, is pressed (i.e., tapped), a screen (first setting screen) for carrying out scaling-up settings is displayed on the screen 20 as illustrated in (b) of FIG. 36.

On the first setting screen, settings 1 through 4 are displayed as illustrated in (b) of FIG. 36. Note that the settings displayed on the first setting screen are not limited to the settings 1 through 4. In a case where the setting 3 is tapped, a screen (second setting screen) for carrying out the scaling-up setting for the setting 3 is displayed on the screen 20 as illustrated in (c) of FIG. 36. Here, in a case where “SCALE UP 1”, which is displayed in the second row and indicates a mode of an instruction on displaying the first scaled-up screen 202, is tapped, a radio button located on the left of “SCALE UP 1” becomes selected (see (c) of FIG. 36). In a case where a return key or a home key (not illustrated) is tapped during the selected state, the scaling-up setting is completed, and the screen 20 changes to the screen 20 illustrated in (a) of FIG. 36.

Note that, in (c) of FIG. 36, “NORMAL DISPLAY” indicates a mode of an instruction on displaying the normal display screen 201, and “SCALE UP 2” indicates a mode of an instruction on displaying the second scaled-up screen 203. “ARBITRARY” is a mode in which scaling-up and scaling-down instructions, such as pinch-in and pinch-out carried out by movements of user's fingers, are activated. Note that the modes of instructions displayed on the screen 20 illustrated in (c) of FIG. 36 are not limited to those described above. Moreover, the mode of “ARBITRARY” is not limited only to pinch-in and pinch-out.

(Scaling-Up and Scaling-Down Process)

(a) of FIG. 37 illustrates a list of thumbnail images 12 displayed on the normal display screen 201, in accordance with Embodiment 4. (b) of FIG. 37 illustrates a list of thumbnail images 12 displayed on the first scaled-up screen 202. (c) of FIG. 37 illustrates a list of thumbnail images 12 displayed on the second scaled-up screen 203.

Here, it is assumed that the scaling-up setting has been carried out as illustrated in FIG. 36. In this case, when the user gives an instruction on scaling up on the normal display screen 201 illustrated in (a) of FIG. 37, a thumbnail image 12, which is displayed on the upper left out of a plurality of thumbnail images 12 currently displayed on the normal display screen 201, becomes a specified thumbnail image 12 (specified content). In the case illustrated in (a) of FIG. 37, the specified thumbnail image 12 is a thumbnail (5). Then, as illustrated in (b) of FIG. 37, the arrangement of the plurality of thumbnail images 12, which have been scaled up, is changed such that the thumbnail (5) is displayed in the first row on the first scaled-up screen 202.

In a case where (i) the display screen has been set in advance such that the first scaled-up screen 202 is to be changed to the second scaled-up screen 203 and (ii) the user gives an instruction on scaling up on the first scaled-up screen 202, a thumbnail (4) becomes a specified content as illustrated in (b) of FIG. 37. Then, as illustrated in (c) of FIG. 37, the arrangement of the plurality of thumbnail images 12, which have been scaled up, is changed such that the thumbnail (4) is displayed in the first row on the second scaled-up screen 203.

Note that, according to Embodiment 4, it is preferable that the screen 20, in which the plurality of thumbnail images 12 are scaled up, is displayed without performing an animation. Note, however, that whether or not an animation is performed is not limited to this, and animations of scaling up and moving can be performed.

The instruction, given by the user, on scaling up the plurality of thumbnail images 12 displayed on the screen 20 can be, for example, (i) pressing on a button indicative of scaling up or (ii) tapping an arbitrary location on the screen 20. Note that the instruction given by the user is not limited to this.

As above described, according to the present invention, the content display device is intended to be used as an electronic book terminal for reading an electronic book. Note, however, that the content display device is not limited to this and can be (i) a mobile terminal such as a mobile phone, a smart phone, or an electronic dictionary or (ii) a terminal device such as a personal computer including a monitor.

The objective of the present invention can be achieved, by (i) supplying a storage medium, in which program codes of the programs are stored so that a computer can read them, to the content display device 1, and then (ii) causing the content display device 1 to read and execute the program codes stored in the storage medium.

The storage medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM, or flash ROM.

The program codes can be supplied to the content display device 1 via a communications network 260 connected with a network communication device. The communications network is not limited to a specific one, and therefore can be, for example, the Internet, an intranet, extranet, LAN, ISDN, VAN, CATV communications network, virtual private network, telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR, mobile telephone network, satellite line, or terrestrial digital network. Note that, the present invention can be realized by a computer data signal (i) which is realized by electronic transmission of the program code and (ii) which is embedded in a carrier wave.

The present invention is not limited to the embodiments, but can be altered by a skilled person in the art within the scope of the claims. An embodiment derived from a proper combination of technical means disclosed in respective different embodiments is also encompassed in the technical scope of the present invention.

(Preferable Configuration of Present Invention)

As above described, the content display device of the present invention includes: display means for displaying a plurality of contents on a screen in a first arrangement, which is a predetermined arrangement order of contents; input means for accepting, from a user, an input of an instruction on changing a display size of a specified content which is any of the plurality of contents displayed on the screen; changing means for changing a display size of a predetermined number of contents when the input has been accepted, the predetermined number of contents (i) including the specified content and (ii) being sequentially arranged on the screen in accordance with the predetermined arrangement order; and moving means for moving the predetermined number of contents on the screen such that the predetermined number of contents are displayed on the screen in a second arrangement, which is a predetermined arrangement order of contents and is different from the first arrangement.

According to the configuration, in a case where the user carries out an input of an instruction, with respect to a display of contents, on changing (i.e., scaling up or scaling down) a display size of a specified content which has been specified out of the plurality of contents, the specified content is surely displayed on the screen after the display size has been changed. In other words, the specified content will not disappear from the screen after the display size has been changed. Therefore, the user does not need to scroll the screen in order to display the specified content on the screen after the display size has been changed.

Contents, which respectively precedes and follows the specified content before the display size is changed, are to still precede and follow the specified content, respectively, even after the display size is changed. That is, the plurality of contents will not be displayed in a discrete manner. This allows the user to always feel consistency in the arrangement of the contents, and therefore the user can comfortably operate the content display device.

As such, according to the present invention, it is possible to provide the content display device that has a user interface which can be easily operated by the user.

The method of the present invention for displaying a content includes the steps of: displaying a plurality of contents on a screen in a first arrangement, which is a predetermined arrangement order of contents; accepting, from a user, an input of an instruction on changing a display size of a specified content which is any of the plurality of contents displayed on the screen; changing a display size of a predetermined number of contents when the input has been accepted, the predetermined number of contents (i) including the specified content and (ii) being sequentially arranged on the screen in accordance with the predetermined arrangement order; and moving the predetermined number of contents on the screen such that the predetermined number of contents are displayed on the screen in a second arrangement, which is a predetermined arrangement order of contents and is different from the first arrangement.

According to the configuration, it is possible to bring about an effect similar to that of the content display device of the present invention.

According to the content display device of the present invention, it is preferable that the moving means moves the predetermined number of contents so that a display location of the content, whose display size has been changed, at least partially overlaps with a display location of the specified content whose display size has not been changed.

According to the configuration, the content specified by the user is displayed at locations close to each other before and after the display size is changed. Therefore, the user does not need to look for the specified content, and accordingly user-friendliness is further improved.

According to the content display device of the present invention, it is preferable that coordinates of a display location of each of the contents, which are arranged in the first arrangement, are determined in advance; coordinates of a display location of each of the contents, which are arranged in the second arrangement, are determined in advance; and the moving means determines a destination of each of the predetermined number of contents based on the coordinates of the content arranged in the first arrangement and on the coordinates of the content arranged in the second arrangement.

With the configuration, when the input means accepts an instruction from the user, the moving means can immediately move the predetermined number of contents.

According to the content display device of the present invention, it is preferable that the instruction is an instruction on scaling up the display size of the plurality of contents; in the first arrangement, the plurality of contents are arranged in a first matrix; and in the second arrangement, contents, which are fewer than the plurality of contents, are arranged in a second matrix, the number of rows or the number of columns of the second matrix being smaller than that of the first matrix or the number of rows and the number of columns of the second matrix being smaller than those of the first matrix.

As such, in a case where the content display device accepts, from the user, an instruction on scaling up the display size of the plurality of contents, the content display device can display, on the screen, the plurality of contents which have been scaled up and are arranged in a matrix in which number of columns and number of rows are smaller than those before the display size is scaled up.

According to the content display device of the present invention, it is preferable that the instruction is an instruction on scaling down the display size of the plurality of contents; in the first arrangement, the plurality of contents are arranged in a first matrix; and in the second arrangement, contents, which are more than the plurality of contents, are arranged in a second matrix, the number of rows or the number of columns of the second matrix being larger than that of the first matrix or the number of rows and the number of columns of the second matrix being larger than those of the first matrix.

As such, in response to an instruction from the user on scaling down the display size of the plurality of contents, the content display device can display, on the screen, the plurality of contents which have been scaled down and are arranged in a matrix larger than that in which the plurality of contents are arranged before being scaled down.

According to the content display device of the present invention, it is preferable that, after the changing means changes the display size of the predetermined number of contents, the moving means moves the predetermined number of contents whose display size has been changed.

This allows the user to give an instruction on changing the display size while confirming the display size of the predetermined number of contents on the screen.

According to the content display device of the present invention, it is preferable that a process for changing the display size of the predetermined number of contents is carried out by the changing means simultaneously with a process for moving the predetermined number of contents which is carried out by the input means.

As such, in a case where (i) the changing process for changing the display size of the predetermined number of contents and (ii) the moving process for moving the predetermined number of contents by the input means are simultaneously carried out, the user can confirm the predetermined number of contents, which have been changed in display size and moved, immediately after the user gives an instruction on changing the display size.

According to the content display device of the present invention, it is preferable that the input means detects the input which is made by the user pressing on the screen.

According to the configuration, a user can intuitively operate the content display device. That is, even a user who operates the content display device for the first time and a user who is unaccustomed to operate apparatuses can operate the content display device without difficulty.

According to the content display device of the present invention, it is preferable that each of the contents is a thumbnail image.

Note that the content display device can be realized by a computer. In such a case, the present invention encompasses (i) a program which causes the computer to serve as each of the means of the content display device and (ii) a computer-readable storage medium in which the program is stored.

### INDUSTRIAL APPLICABILITY

The present invention is applicable to a terminal that displays, on a screen, thumbnail images and icons, etc. of a plurality of contents. In particular, the present invention can be suitably applied to a mobile electronic book terminal.

### REFERENCE SIGNS LIST

1: Content display device
10: Bookshelf object
11: Shelf surface
12, 12′: Thumbnail image (content)
13: Shelf
14: Area
19: Close button
20: Screen
101: Input processing section
102: Network processing section
103: Activation processing section
104: Book data managing section
105: Display information managing section
106: Rotation processing section
107: Scroll processing section
108: Book list display processing section
109: Book content display processing section
110: Output processing section
111: Input operation section (input means)
112: Display section (display means)
113: Communication section
121: Coordinate calculation processing section (moving means)
122: Coordinate managing section
123: Scaling up/down display processing section (changing means)
124: Moving display processing section (moving means)
125: Fitting display processing section
201: Normal display screen
202: First scaled-up screen
203: Second scaled-up screen

1. A content display device comprising:
display means for displaying a plurality of contents on a screen in a first arrangement, which is a predetermined arrangement order of contents;
input means for accepting, from a user, an input of an instruction on changing a display size of a specified content which is any of the plurality of contents displayed on the screen;
changing means for changing a display size of a predetermined number of contents when the input has been accepted, the predetermined number of contents (i) including the specified content and (ii) being sequentially arranged on the screen in accordance with the predetermined arrangement order; and
moving means for moving the predetermined number of contents on the screen such that the predetermined number of contents are displayed on the screen in a second arrangement, which is a predetermined arrangement order of contents and is different from the first arrangement.

2. The content display device as set forth in claim 1, wherein:
the moving means moves the predetermined number of contents so that a display location of the content, whose display size has been changed, at least partially overlaps with a display location of the specified content whose display size has not been changed.

3. The content display device as set forth in claim 1, wherein:
coordinates of a display location of each of the contents, which are arranged in the first arrangement, are determined in advance;
coordinates of a display location of each of the contents, which are arranged in the second arrangement, are determined in advance; and
the moving means determines a destination of each of the predetermined number of contents based on the coordinates of the content arranged in the first arrangement and on the coordinates of the content arranged in the second arrangement.

4. The content display device as set forth in claim 1, wherein:
the instruction is an instruction on scaling up the display size of the plurality of contents;
in the first arrangement, the plurality of contents are arranged in a first matrix; and
in the second arrangement, contents, which are fewer than the plurality of contents, are arranged in a second matrix, the number of rows or the number of columns of the second matrix being smaller than that of the first matrix or the number of rows and the number of columns of the second matrix being smaller than those of the first matrix.

5. The content display device as set forth in claim 1, wherein:
the instruction is an instruction on scaling down the display size of the plurality of contents;
in the first arrangement, the plurality of contents are arranged in a first matrix; and
in the second arrangement, contents, which are more than the plurality of contents, are arranged in a second matrix, the number of rows or the number of columns of the second matrix being larger than that of the first matrix or the number of rows and the number of columns of the second matrix being larger than those of the first matrix.

6. The content display device as set forth in claim 1, wherein:
after the changing means changes the display size of the predetermined number of contents, the moving means moves the predetermined number of contents whose display size has been changed.

7. The content display device as set forth in claim 1, wherein:
a process for changing the display size of the predetermined number of contents is carried out by the changing means simultaneously with a process for moving the predetermined number of contents which is carried out by the moving means.

8. The content display device as set forth in claim 1 wherein the input means detects the input which is made by the user pressing on the screen.

9. The content display device as set forth in claim 1 wherein each of the contents is a thumbnail image.

10. A method for displaying a content with use of a content display device, said method comprising the steps of:
displaying a plurality of contents on a screen in a first arrangement, which is a predetermined arrangement order of contents;
accepting, from a user, an input of an instruction on changing a display size of a specified content which is any of the plurality of contents displayed on the screen;
changing a display size of a predetermined number of contents when the input has been accepted, the predetermined number of contents (i) including the specified content and (ii) being sequentially arranged on the screen in accordance with the predetermined arrangement order; and
moving the predetermined number of contents on the screen such that the predetermined number of contents are displayed on the screen in a second arrangement, which is a predetermined arrangement order of contents and is different from the first arrangement.

11. (canceled)

12. A computer-readable non-transitory storage medium in which a program for causing a computer to operate as a content display device as in claim 1 is stored.

13. The content display device as set forth in claim 2, wherein:
coordinates of a display location of each of the contents, which are arranged in the first arrangement, are determined in advance;
coordinates of a display location of each of the contents, which are arranged in the second arrangement, are determined in advance; and
the moving means determines a destination of each of the predetermined number of contents based on the coordinates of the content arranged in the first arrangement and on the coordinates of the content arranged in the second arrangement.

14. The content display device as set forth in claim 2, wherein:
the instruction is an instruction on scaling up the display size of the plurality of contents;
in the first arrangement, the plurality of contents are arranged in a first matrix; and
in the second arrangement, contents, which are fewer than the plurality of contents, are arranged in a second matrix, the number of rows or the number of columns of the second matrix being smaller than that of the first matrix or the number of rows and the number of columns of the second matrix being smaller than those of the first matrix.

15. The content display device as set forth in claim 3, wherein:
the instruction is an instruction on scaling up the display size of the plurality of contents;
in the first arrangement, the plurality of contents are arranged in a first matrix; and
in the second arrangement, contents, which are fewer than the plurality of contents, are arranged in a second matrix, the number of rows or the number of columns of the second matrix being smaller than that of the first matrix or the number of rows and the number of columns of the second matrix being smaller than those of the first matrix.

16. The content display device as set forth in claim 2, wherein:
the instruction is an instruction on scaling down the display size of the plurality of contents;
in the first arrangement, the plurality of contents are arranged in a first matrix; and
in the second arrangement, contents, which are more than the plurality of contents, are arranged in a second matrix, the number of rows or the number of columns of the second matrix being larger than that of the first matrix or the number of rows and the number of columns of the second matrix being larger than those of the first matrix.

17. The content display device as set forth in claim 3, wherein:
the instruction is an instruction on scaling down the display size of the plurality of contents;
in the first arrangement, the plurality of contents are arranged in a first matrix; and
in the second arrangement, contents, which are more than the plurality of contents, are arranged in a second matrix, the number of rows or the number of columns of the second matrix being larger than that of the first matrix or the number of rows and the number of columns of the second matrix being larger than those of the first matrix.

18. The content display device as set forth in claim 4, wherein:
the instruction is an instruction on scaling down the display size of the plurality of contents;
in the first arrangement, the plurality of contents are arranged in a first matrix; and
in the second arrangement, contents, which are more than the plurality of contents, are arranged in a second matrix, the number of rows or the number of columns of the second matrix being larger than that of the first matrix or the number of rows and the number of columns of the second matrix being larger than those of the first matrix.

19. The content display device as set forth in claim 2, wherein:
after the changing means changes the display size of the predetermined number of contents, the moving means moves the predetermined number of contents whose display size has been changed.

20. The content display device as set forth in claim 3, wherein:
after the changing means changes the display size of the predetermined number of contents, the moving means moves the predetermined number of contents whose display size has been changed.

21. The content display device as set forth in claim 4, wherein:
after the changing means changes the display size of the predetermined number of contents, the moving means moves the predetermined number of contents whose display size has been changed.
